(19) United States
(12) Patent Application Publication
(10) Pub. No.: US 2026/0155089 A1
(43) Pub. Date: Jun. 4, 2026

(54) DISPLAY DEVICE AND ELECTRONIC DEVICE

(71) Applicant: Samsung Display Co., LTD., Yongin-si (KR)

(72) Inventors: GYEONG-UB MOON, Yongin-si (KR); SEUNGHYUN MOON, Yongin-si (KR); KANGBIN JO, Yongin-si (KR); GOEUN CHA, Yongin-si (KR); BORAM CHOI, Yongin-si (KR)

(21) Appl. No.: 19/222,020

(22) Filed: May 29, 2025

(30) Foreign Application Priority Data
Dec. 2, 2024 (KR) 10-2024-0176224

(51) Int. Cl. G09G 3/32; G09G 3/3225

(52) U.S. Cl. CPC G09G 3/32; G09G 3/3225; G09G 2320/0242; G09G 2320/068; G09G 2330/021; G09G 2340/0457

(57) ABSTRACT

A display device includes a display panel including normal subpixels having a first viewing angle and private subpixels having a second viewing angle, which are arranged in a first pixel arrangement structure, and a panel driver, which receives input image data corresponding to a second pixel arrangement structure different from the first pixel arrangement structure, and drives the display panel. In a private mode, the panel driver performs a resolution-reduction rendering operation, which adjusts each subpixel data based on adjacent subpixel data, performs a pixel arrangement rendering operation on the input image data on which the resolution-reduction rendering operation is performed, performs a private rendering operation on the input image data on which the resolution-reduction rendering operation and the pixel arrangement rendering operation are performed to generate second output image data, and drives only the private subpixels based on the second output image data.

This application claims priority to Korean Patent Application No. 10-2024-0176224, filed on Dec. 2, 2024, and all the benefits accruing therefrom under 35 U.S.C. § 119, the content of which in its entirety is herein incorporated by reference.

### BACKGROUND

### 1. Field

Embodiments relate normally to display devices, and more particularly to a display device that operates in a normal mode and a private mode, and an electronic device including the display device.

### 2. Description of the Related Art

In normal, a display device may display an image with a wide viewing angle such that, not only a user positioned in front of the display device, but also a user positioned on the side of the display device can view the image. However, recently, to protect personal information or to ensure safety in a display device mounted in a vehicle, a private mode (or a privacy mode) has been developed in which the display device displays an image only to a user located in front of the display device. For example, a vehicle display device located corresponding to a passenger seat of a vehicle may operate not only in a normal mode (or a public mode) in which an image is displayed with a wide viewing angle such that the image is provided to both of a driver and a passenger, but also in a private mode in which an image is displayed with a narrow viewing angle such that the image is provided only to the passenger.

### SUMMARY

Some embodiments provide a display device capable of reducing or preventing a color shift phenomenon in a private mode (and/or a normal mode).

Some embodiments provide an electronic device including the display device.

According to embodiments, there is provided a display device including a display panel including a plurality of normal subpixels having a first viewing angle and a plurality of private subpixels having a second viewing angle different from the first viewing angle, the plurality of normal subpixels and the plurality of private subpixels being arranged in a first pixel arrangement structure, and a panel driver configured to receive input image data corresponding to a second pixel arrangement structure different from the first pixel arrangement structure, and to drive the display panel. In a normal mode, the panel driver performs a pixel arrangement rendering operation on the input image data corresponding to the second pixel arrangement structure to generate first output image data corresponding to the first pixel arrangement structure, and drives the plurality of normal subpixels and the plurality of private subpixels based on the first output image data. In a private mode, the panel driver performs a resolution-reduction rendering operation that adjusts each subpixel data included in the input image data based on adjacent subpixel data included in the input image data, performs the pixel arrangement rendering operation on the input image data on which the resolution-reduction rendering operation is performed, performs a private rendering operation on the input image data on which the resolution-reduction rendering operation and the pixel arrangement rendering operation are performed to generate second output image data, and drives only the plurality of private subpixels among the plurality of normal subpixels and the plurality of private subpixels based on the second output image data.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data horizontally adjacent to the each red subpixel data among the plurality of red subpixel data in the second pixel arrangement structure, may adjust each green subpixel data based on two green subpixel data horizontally adjacent to the each green subpixel data among the plurality of green subpixel data in the second pixel arrangement structure, and may adjust each blue subpixel data based on two blue subpixel data horizontally adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data vertically adjacent to the each red subpixel data among the plurality of red subpixel data in the second pixel arrangement structure, may adjust each green subpixel data based on two green subpixel data vertically adjacent to the each green subpixel data among the plurality of green subpixel data in the second pixel arrangement structure, and may adjust each blue subpixel data based on two blue subpixel data vertically adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data horizontally adjacent to the each red subpixel data and two red subpixel data vertically adjacent to the each red subpixel data among the plurality of red subpixel data in the second pixel arrangement structure, may adjust each green subpixel data based on two green subpixel data horizontally adjacent to the each green subpixel data and two green subpixel data vertically adjacent to the each green subpixel data among the plurality of green subpixel data in the second pixel arrangement structure, and may adjust each blue subpixel data based on two blue subpixel data horizontally adjacent to the each blue subpixel data and two blue subpixel data vertically adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on four red subpixel data diagonally adjacent to the each red subpixel data among the plurality of red subpixel data in the second pixel arrangement structure, may adjust each green subpixel data based on four green subpixel data diagonally adjacent to the each green subpixel data among the plurality of green subpixel data in the second pixel arrangement structure, and may adjust each blue subpixel data based on four blue subpixel data diagonally adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data horizontally adjacent to the each red subpixel data, two green subpixel data vertically adjacent to the each green subpixel data, and four red subpixel data diagonally adjacent to the each red subpixel data among the plurality of red subpixel data in the second pixel arrangement structure, may adjust each green subpixel data based on two green subpixel data horizontally adjacent to the each green subpixel data, two green subpixel data vertically adjacent to the each green subpixel data, and four green subpixel data diagonally adjacent to the each green subpixel data among the plurality of green subpixel data in the second pixel arrangement structure, and may adjust each blue subpixel data based on two blue subpixel data horizontally adjacent to the each blue subpixel data, two blue subpixel data vertically adjacent to the each blue subpixel data, and four blue subpixel data diagonally adjacent to the each blue subpixel data among the plurality of blue subpixel data in the second pixel arrangement structure.

In embodiments, in the first pixel arrangement structure, each subpixel may include two first color subpixels, one second color subpixel, and one third color subpixel, which are arranged at four corners of a diamond shapes, respectively, and the two first color subpixels are arranged at corners opposite to each other among the four corners, and in the second pixel arrangement structure, each subpixel may include one first color subpixel, one second color subpixel, and one third color subpixel, which are sequentially arranged in one direction.

In embodiments, the plurality of normal subpixels may include normal red subpixels, normal green subpixels and normal blue subpixels, and the plurality of private subpixels may include private red subpixels, private green subpixels and private blue subpixels. One normal red subpixel among the normal red subpixels, two normal green subpixels among the normal green subpixels, and one normal blue subpixel among the normal blue subpixels may be arranged at four corners of a diamond shape, respectively, and one private red subpixel among the private red subpixels, two private green subpixels among the private green subpixels, and one private blue subpixel among the private blue subpixels may be arranged at four corners of a diamond shape, respectively.

In embodiments, the input image data may include a plurality of red subpixel data, a plurality of green subpixel data and a plurality of blue subpixel data. In the pixel arrangement rendering operation, the panel driver may generate each subpixel data for each of the normal red subpixels or each of the private red subpixels based on adjacent two red subpixel data among the plurality of red subpixel data, may generate each subpixel data for each of the normal green subpixels or each of the private green subpixels based on adjacent two green subpixel data among the plurality of green subpixel data, and may generate each subpixel data for each of the normal blue subpixels or each of the private blue subpixels based on adjacent two blue subpixel data among the plurality of blue subpixel data.

In embodiments, in the private rendering operation, the panel driver may convert the subpixel data for the plurality of normal subpixels into minimum level data among the subpixel data included in the input image data on which the resolution-reduction rendering operation and the pixel arrangement rendering operation are performed.

In embodiments, the panel driver may include a scan driver configured to provide scan signals to the plurality of normal subpixels and the plurality of private subpixels, a data driver configured to provide data signals to the plurality of normal subpixels and the plurality of private subpixels based on the first output data in the normal mode, and to provide data signals to the plurality of private subpixels based on the second output data in the private mode, and a controller configured to generate the first output image data by performing the pixel arrangement rendering operation on the input image data in the normal mode, and to generate the second output image data by performing the resolution-reduction rendering operation, the pixel arrangement rendering operation and the private rendering operation on the input image data in the private mode.

In embodiments, the controller may include a resolution-reduction rendering block configured to perform the resolution-reduction rendering operation on the input image data in the private mode, a pixel arrangement rendering block configured to perform the pixel arrangement rendering operation on the input image data in the normal mode, and to perform the pixel arrangement rendering operation on the input image data on which the resolution-reduction rendering operation is performed in the private mode, and a mode rendering block configured to perform the private rendering operation on the input image data on which the resolution-reduction rendering operation and the pixel arrangement rendering operation are performed in the private mode.

According to embodiments, there is provided a display device including a display panel including a plurality of normal subpixels having a first viewing angle and a plurality of private subpixels having a second viewing angle different from the first viewing angle, the plurality of normal subpixels and the plurality of private subpixels being arranged in a first pixel arrangement structure, and a panel driver configured to receive input image data corresponding to a second pixel arrangement structure different from the first pixel arrangement structure, and to drive the display panel. In a normal mode, the panel driver performs a resolution-reduction rendering operation that adjusts each subpixel data included in the input image data based on adjacent subpixel data included in the input image data, performs a pixel arrangement rendering operation on the input image data on which the resolution-reduction rendering operation is performed, performs a normal rendering operation on the input image data on which the resolution-reduction rendering operation and the pixel arrangement rendering operation are performed to generate first output image data, and drives only the plurality of normal subpixels among the plurality of normal subpixels and the plurality of private subpixels based on the first output image data. In a private mode, the panel driver performs the resolution-reduction rendering operation on the input image data, performs the pixel arrangement rendering operation on the input image data on which the resolution-reduction rendering operation is performed, performs a private rendering operation on the input image data on which the resolution-reduction rendering operation and the pixel arrangement rendering operation are performed to generate second output image data, and drives only the plurality of private subpixels among the plurality of normal subpixels and the plurality of private subpixels based on the second output image data.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data horizontally adjacent to the each red subpixel data among the plurality of red subpixel data in the second pixel arrangement structure, may adjust each green subpixel data based on two green subpixel data horizontally adjacent to the each green subpixel data among the plurality of green subpixel data in the second pixel arrangement structure, and may adjust each blue subpixel data based on two blue subpixel data horizontally adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data vertically adjacent to the each red subpixel data among the plurality of red subpixel data in the second pixel arrangement structure, may adjust each green subpixel data based on two green subpixel data vertically adjacent to the each green subpixel data among the plurality of green subpixel data in the second pixel arrangement structure, and may adjust each blue subpixel data based on two blue subpixel data vertically adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data horizontally adjacent to the each red subpixel data and two red subpixel data vertically adjacent to the each red subpixel data among the plurality of red subpixel data in the second pixel arrangement structure, may adjust each green subpixel data based on two green subpixel data horizontally adjacent to the each green subpixel data and two green subpixel data vertically adjacent to the each green subpixel data among the plurality of green subpixel data in the second pixel arrangement structure, and may adjust each blue subpixel data based on two blue subpixel data horizontally adjacent to the each blue subpixel data and two blue subpixel data vertically adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on four red subpixel data diagonally adjacent to the each red subpixel data among the plurality of red subpixel data in the second pixel arrangement structure, may adjust each green subpixel data based on four green subpixel data diagonally adjacent to the each green subpixel data among the plurality of green subpixel data in the second pixel arrangement structure, and may adjust each blue subpixel data based on four blue subpixel data diagonally adjacent to the each blue subpixel data among the plurality of blue subpixel data in the second pixel arrangement structure.

In embodiments, the input image data may include a plurality of red subpixel data, a plurality of green subpixel data and a plurality of blue subpixel data. In the resolution-reduction rendering operation, the panel driver may adjust each red subpixel data based on two red subpixel data horizontally adjacent to the each red subpixel data, two red subpixel data vertically adjacent to the each red subpixel data, and four red subpixel data diagonally adjacent to the each red subpixel data among the plurality of red subpixel data in the second pixel arrangement structure, may adjust each green subpixel data based on two green subpixel data horizontally adjacent to the each green subpixel data, two green subpixel data vertically adjacent to the each green subpixel data, and four green subpixel data diagonally adjacent to the each green subpixel data among the plurality of green subpixel data in the second pixel arrangement structure, and may adjust each blue subpixel data based on two blue subpixel data horizontally adjacent to the each blue subpixel data, two blue subpixel data vertically adjacent to the each blue subpixel data, and four blue subpixel data diagonally adjacent to the each blue subpixel data among the plurality of blue subpixel data in the second pixel arrangement structure.

In embodiments, in the normal rendering operation, the panel driver may convert the subpixel data for the plurality of private subpixels into minimum level data among the subpixel data included in the input image data on which the resolution-reduction rendering operation and the pixel arrangement rendering operation are performed. In the private rendering operation, the panel driver may convert the subpixel data for the plurality of normal subpixels into the minimum level data among the subpixel data included in the input image data on which the resolution-reduction rendering operation and the pixel arrangement rendering operation are performed.

According to embodiments, there is provided an electronic device including a processor configured to provide input image data and a mode signal, a display panel including a plurality of normal subpixels having a first viewing angle and a plurality of private subpixels having a second viewing angle different from the first viewing angle, the plurality of normal subpixels and the plurality of private subpixels being arranged in a first pixel arrangement structure, and a panel driver configured to receive the input image data corresponding to a second pixel arrangement structure different from the first pixel arrangement structure from the processor, to receive the mode signal indicating a normal mode or a private mode from the processor, and to drive the display panel. In a case where the mode signal indicates the private mode, the panel driver performs a resolution-reduction rendering operation that adjusts each subpixel data included in the input image data based on adjacent subpixel data included in the input image data, performs a pixel arrangement rendering operation on the input image data on which the resolution-reduction rendering operation is performed, performs a private rendering operation on the input image data on which the resolution-reduction rendering operation and the pixel arrangement rendering operation are performed to generate output image data, and drives only the plurality of private subpixels based on the output image data.

As described above, in a display device and an electronic device according to embodiments, in a private mode, a panel driver may generate output image data by performing a resolution-reduction rendering operation, a pixel arrangement rendering operation and a private rendering operation on input image data, and may drive only a plurality of private subpixels among the plurality of normal subpixels and the plurality of private subpixels based on the output image data. Accordingly, a color shift phenomenon may be effectively reduced or prevented in the private mode (and/or a normal mode).

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a diagram illustrating an example of a display panel included in a display device according to embodiments.

FIG. 3A is a diagram illustrating an example of a display panel in which all subpixels emit light in a normal mode, and FIG. 3B is a diagram illustrating another example of a display panel in which only a plurality of normal subpixels emit light in a normal mode.

FIG. 4 is a diagram illustrating an example of a display panel in which only a plurality of private subpixels emit light in a private mode.

FIG. 5 is a diagram illustrating an example of input image data.

FIG. 6A is a diagram illustrating an example of image data generated by performing a pixel arrangement rendering operation on input image data of FIG. 5 in a conventional display device, and FIG. 6B is a diagram illustrating an example of image data generated by performing a private rendering operation on the image data of FIG. 6A in the conventional display device.

FIG. 7A is a diagram illustrating an example of image data generated by performing a resolution-reduction rendering operation on input image data of FIG. 5 in a display device according to embodiments, FIG. 7B is a diagram illustrating an example of image data generated by performing a pixel arrangement rendering operation on the image data of FIG. 7A in the display device according to embodiments, and FIG. 7C is a diagram illustrating an example of image data generated by performing a private rendering operation on the image data of FIG. 7B in the display device according to embodiments.

FIG. 8 is a flowchart illustrating a method of operating a display device according to embodiments.

FIG. 9 is a diagram for describing an example of a pixel arrangement rendering operation according to embodiments.

FIGS. 10A through 10E are diagrams for describing examples of a resolution-reduction rendering operation according to embodiments.

FIG. 11 is a diagram for describing an example of a private rendering operation according to embodiments.

FIG. 12 is a flowchart illustrating a method of operating a display device according to embodiments.

FIG. 13 is a diagram for describing an example of a normal rendering operation according to embodiments.

FIG. 14 is a block diagram illustrating an electronic device including a display device according to embodiments.

FIG. 15 is a block diagram illustrating an example of an electronic device according to embodiments.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The embodiments are described more fully hereinafter with reference to the accompanying drawings. Like or similar reference numerals refer to like or similar elements throughout.

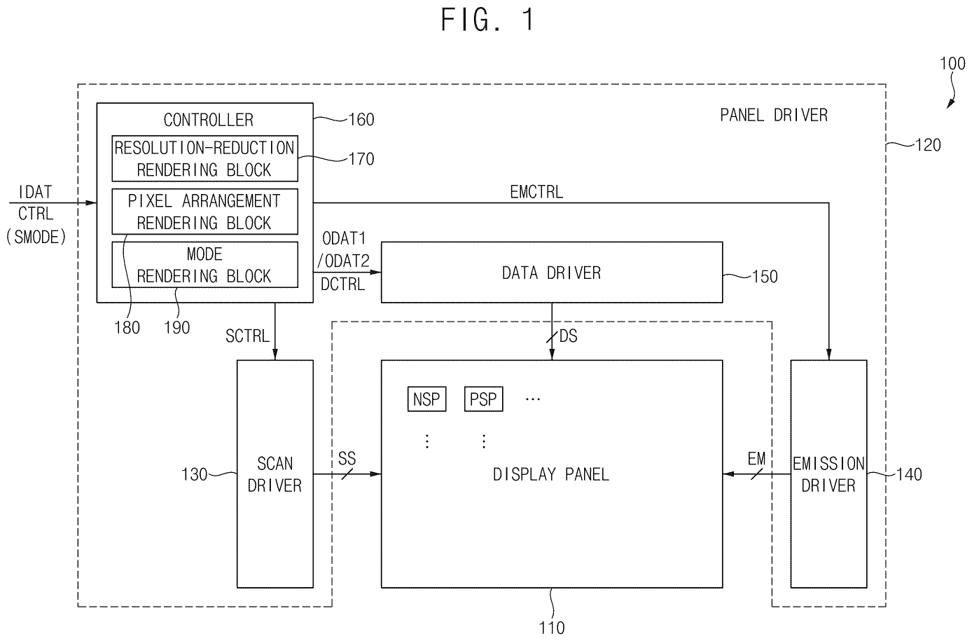

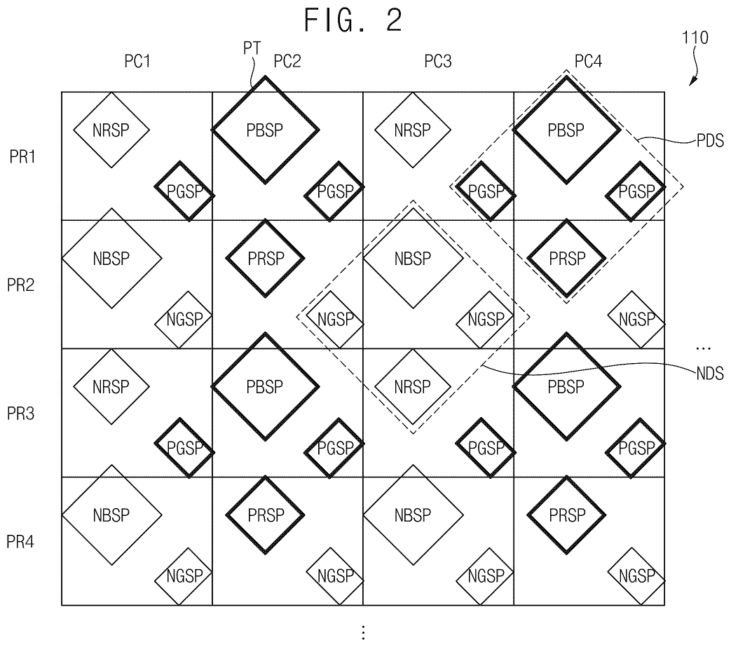

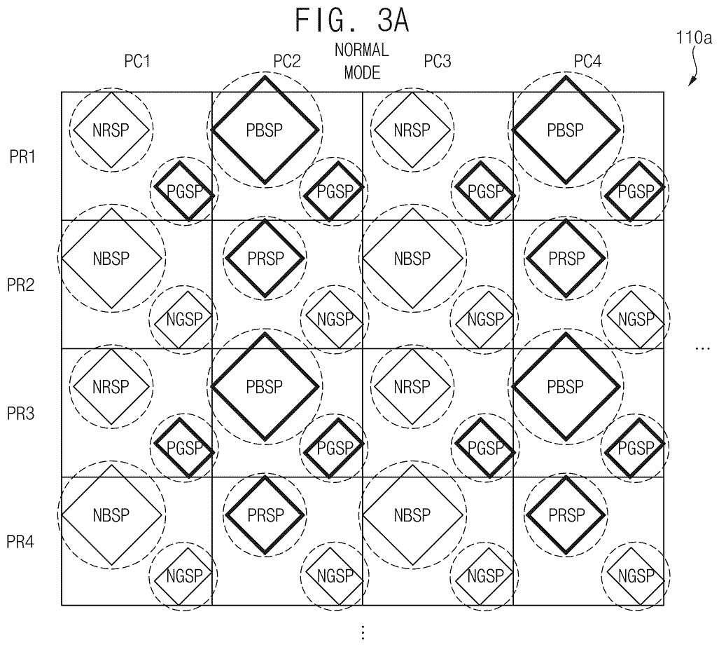

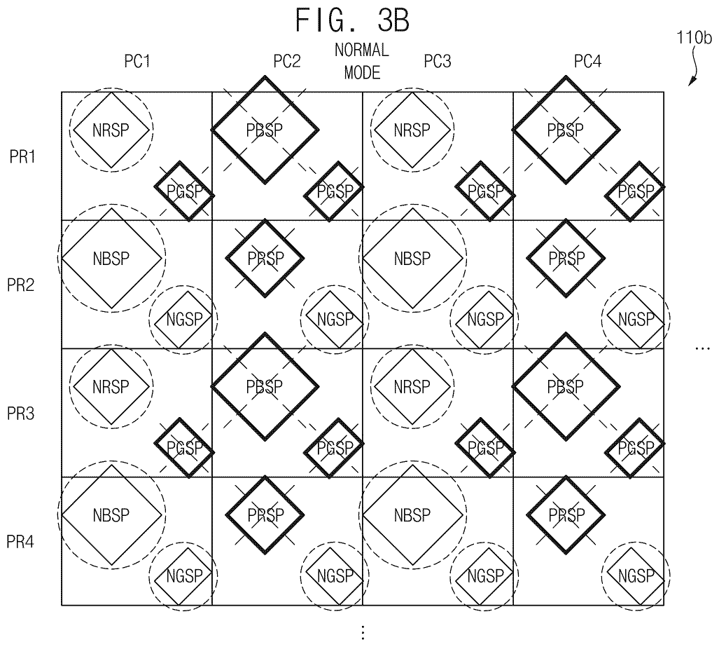

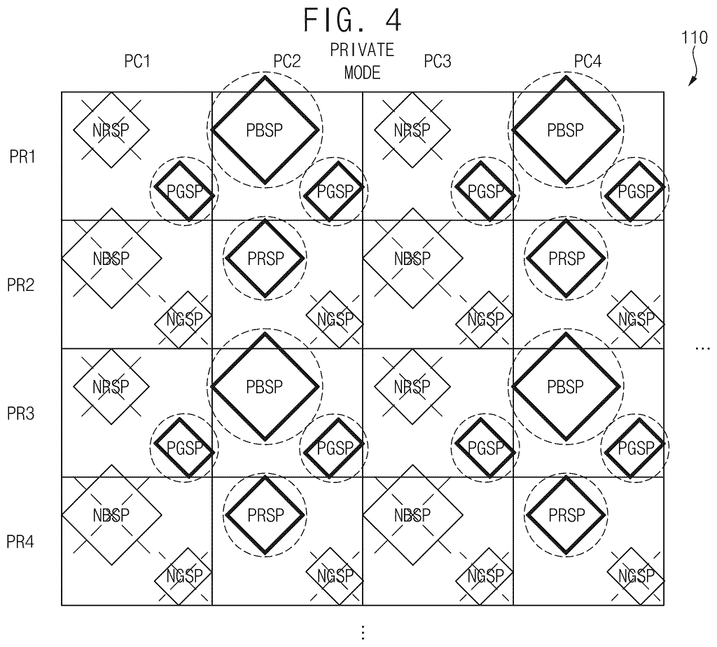

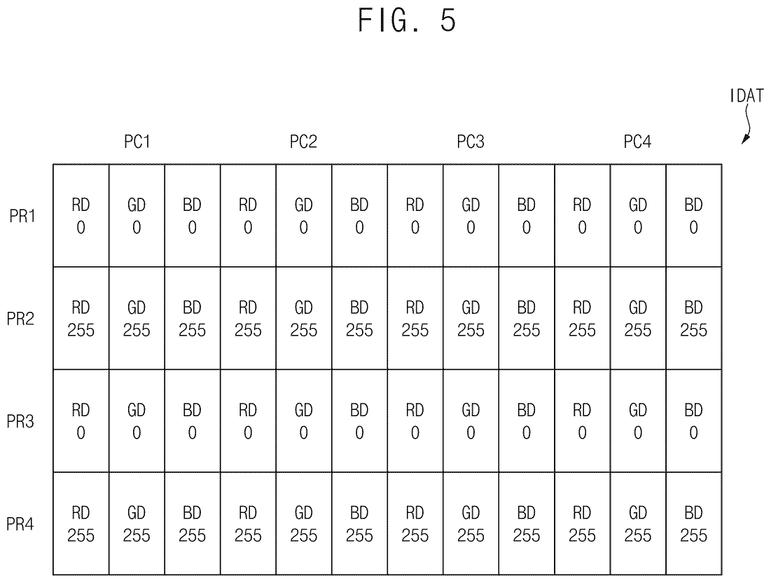

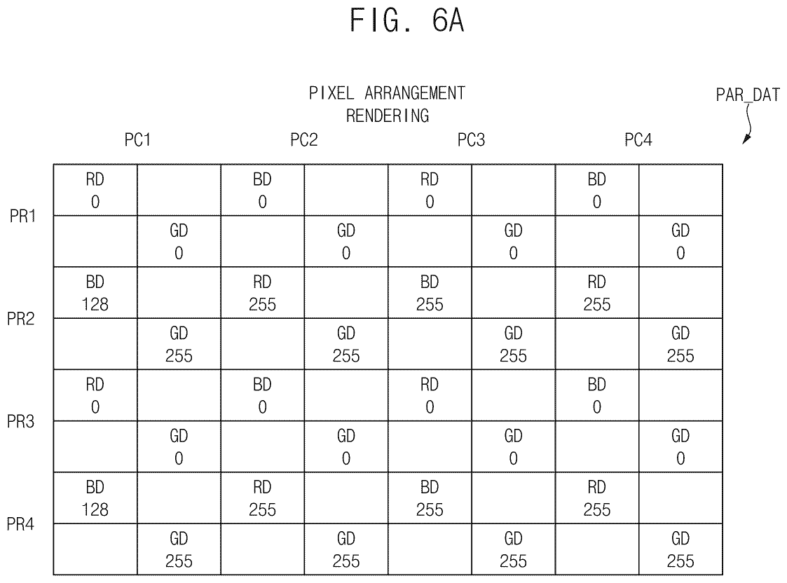

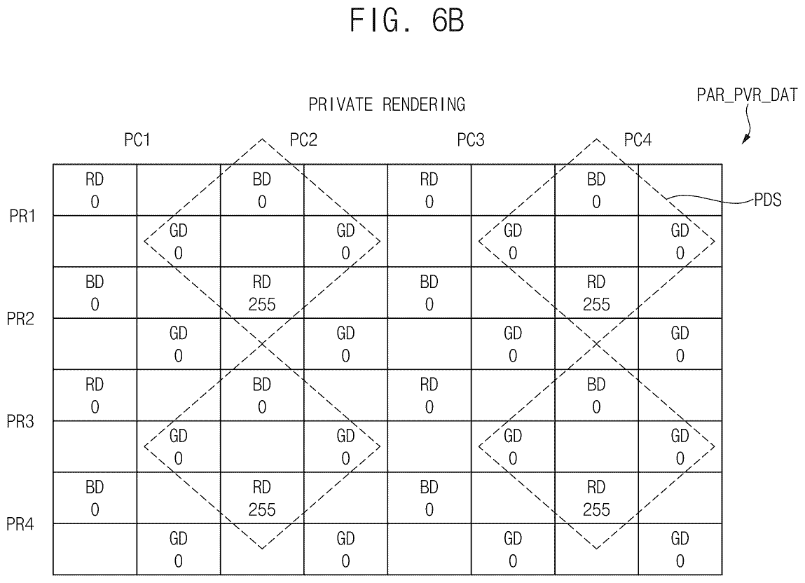

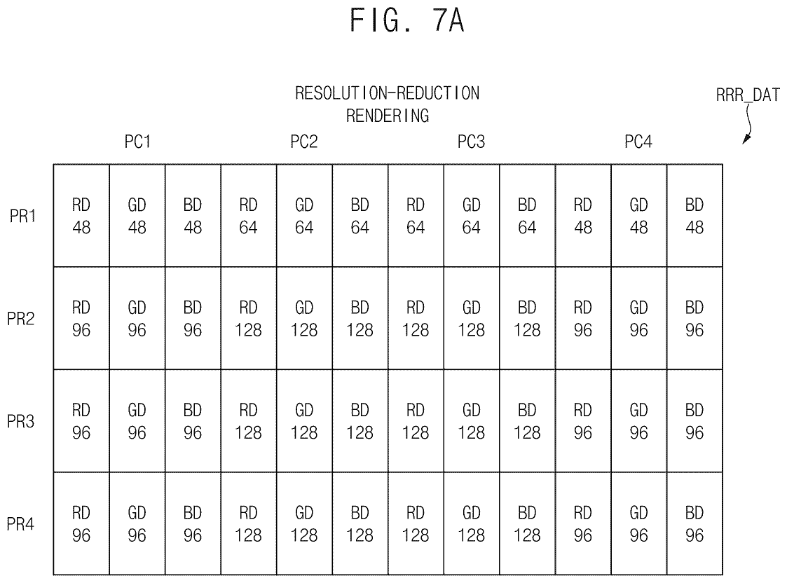

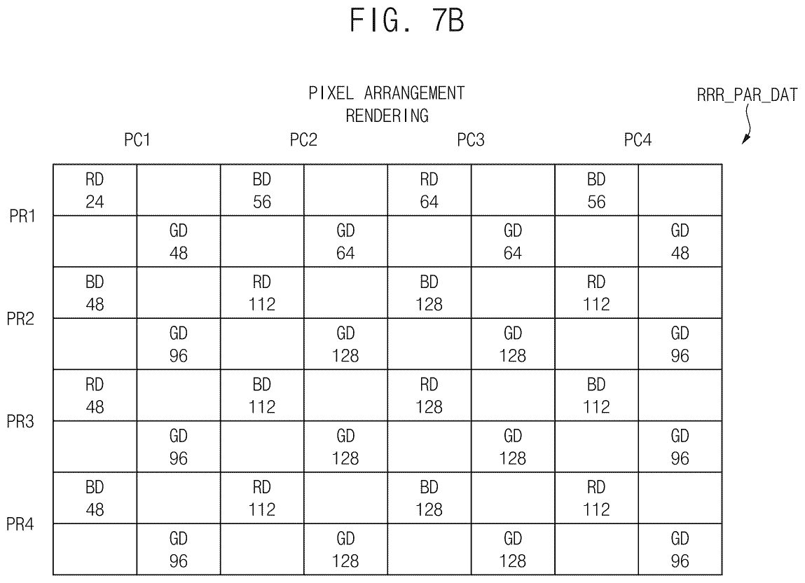

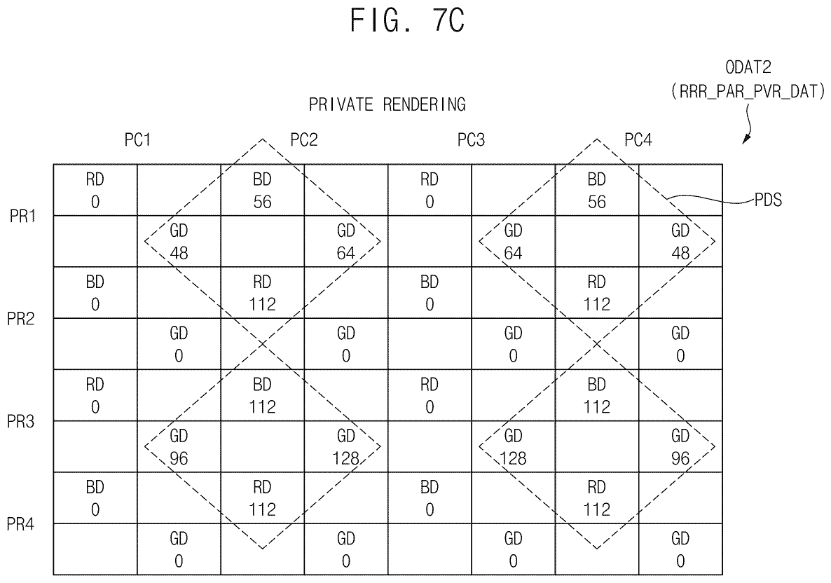

FIG. 1 is a block diagram illustrating a display device according to embodiments, FIG. 2 is a diagram illustrating an example of a display panel included in a display device according to embodiments, FIG. 3A is a diagram illustrating an example of a display panel in which all subpixels emit light in a normal mode, FIG. 3B is a diagram illustrating another example of a display panel in which only a plurality of normal subpixels emit light in a normal mode, FIG. 4 is a diagram illustrating an example of a display panel in which only a plurality of private subpixels emit light in a private mode, FIG. 5 is a diagram illustrating an example of input image data, FIG. 6A is a diagram illustrating an example of image data generated by performing a pixel arrangement rendering operation on input image data of FIG. 5 in a conventional display device, FIG. 6B is a diagram illustrating an example of image data generated by performing a private rendering operation on the image data of FIG. 6A in the conventional display device, FIG. 7A is a diagram illustrating an example of image data generated by performing a resolution-reduction rendering operation on input image data of FIG. 5 in a display device according to embodiments, FIG. 7B is a diagram illustrating an example of image data generated by performing a pixel arrangement rendering operation on the image data of FIG. 7A in the display device according to embodiments, and FIG. 7C is a diagram illustrating an example of image data generated by performing a private rendering operation on the image data of FIG. 7B in the display device according to embodiments. As used herein, the “resolution-reduction rendering operation” means a rendering operation for reducing resolution.

Referring to FIG. 1, a display device 100 according to embodiments may include a display panel 110 that includes a plurality of normal subpixels NSP and a plurality of private subpixels PSP, and a panel driver 120 that drives the display panel 110. The panel driver 120 may include a scan driver 130 that provides scan signals SS to the plurality of normal subpixels NSP and the plurality of private subpixels PSP, a data driver 150 that provides data signals DS to the plurality of normal subpixels NSP and the plurality of private subpixels PSP, and a controller 160 that controls an operation of the display device 100. In some embodiments, the panel driver 120 may further include an emission driver 140 that provides emission signals EM to the plurality of normal subpixels NSP and the plurality of private subpixels PSP.

The display panel 110 may include the plurality of normal subpixels NSP having a first viewing angle, and a plurality of private subpixels PSP having a second viewing angle different from the first viewing angle. In some embodiments, the first viewing angle may be a relatively wide viewing angle, and the second viewing angle may be a relatively narrow viewing angle. Thus, light emitted from the plurality of normal subpixels NSP may be provided to both of a first user positioned in front of the display device 100 and a second user positioned on the side of the display device 100. However, light emitted from the plurality of private subpixels PSP may be provided to the first user positioned in front of the display device 100, but may not be provided to the second user positioned on the side of the display device 100. Further, in some embodiments, each of the normal subpixel NSP and the private subpixel PSP may include a light-emitting element, and the display panel 110 may be a light-emitting display panel. For example, the light-emitting element may be an organic light-emitting diode (“OLED”), a micro light-emitting diode, a nano light-emitting diode (“NED”), a quantum dot (“QD”) light-emitting diode, an inorganic light-emitting diode, or any other suitable light-emitting element.

In the display panel 110, the plurality of normal subpixels NSP and the plurality of private subpixels PSP may be arranged in a first pixel arrangement structure. In some embodiments, the first pixel arrangement structure may be a DIAMOND PIXEL® arrangement structure in which each subpixel includes two first color subpixels, one second color subpixel, and one third color subpixel, which are arranged at four corners of a diamond shapes, respectively, and the two first color subpixels are arranged at corners opposite to each other among the four corners. For example, as illustrated in FIG. 2, the plurality of normal subpixels NSP of the display panel 110 may include normal red subpixels NRSP, normal green subpixels NGSP and normal blue subpixels NBSP, and the plurality of private subpixels PSP of the display panel 110 may include private red subpixels PRSP, private green subpixels PGSP and private blue subpixels PBSP. Each of the private red, green and blue subpixels PRSP, PGSP and PBSP may include a partition PT for preventing light emitted by the light emitting layer from spreading to the side, and thus may have the relatively narrow viewing angle. The normal red subpixel NRSP, the private green subpixel PGSP, the private blue subpixel PBSP and the private green subpixel PGSP may be repeatedly arranged in each odd-numbered pixel row PR1 and PR3, and the private blue subpixel PBSP, the normal green subpixel NGSP, the private red subpixel PRSP and the normal green subpixel NGSP may be repeatedly arranged in each even-numbered pixel row PR2 and PR4, but is not limited thereto. Further, the normal red subpixel NRSP, the private green subpixel PGSP, the normal blue subpixel NBSP and the normal green subpixel NGSP may be repeatedly arranged in each odd-numbered pixel column PC1 and PC3, and the private blue subpixel PBSP, the private green subpixel PGSP, the private red subpixel PRSP and the normal green subpixel NGSP may be repeatedly arranged in each even-numbered pixel column PC2 and PC4, but is not limited thereto. Further, one normal red subpixel NRSP, two normal green subpixels NGSP and one normal blue subpixel NBSP, which are adjacent to each other, may be arranged in a diamond shape NDS, and one private red subpixel PRSP, two private green subpixels PGSP and one private blue subpixel PBSP, which are adjacent to each other, may be arranged in a diamond shape PDS.

Referring again to FIG. 1, the scan driver 130 may generate the scan signals SS based on a scan control signal SCTRL received from the controller 160, and may sequentially provide the scan signals SS to the plurality of normal subpixels NSP and the plurality of private subpixels PSP on a row-by-row basis. In some embodiments, the scan control signal SCTRL may include, but is not limited to, a scan start signal and a scan clock signal. Further, in some embodiments, the scan driver 130 may be integrated or formed in the display panel 110. In other embodiments, the scan driver 130 may be implemented with one or more integrated circuits.

The emission driver 140 may generate the emission signals EM based on an emission control signal EMCTRL received from the controller 160, and may sequentially provide the emission signals EM to the plurality of normal subpixels NSP and the plurality of private subpixels PSP on a row-by-row basis. In some embodiments, the emission control signal EMCTRL may include, but is not limited to, an emission start signal and an emission clock signal. Further, in some embodiments, the emission driver 140 may be integrated or formed in the display panel 110. In other embodiments, the emission driver 140 may be implemented with one or more integrated circuits.

The data driver 150 may generate the data signals DS based on output image data ODAT1/ODAT2 and a data control signal DCTRL received from the controller 160, and may provide the data signals DS to the plurality of normal subpixels NSP and/or the plurality of private subpixels PSP. In some embodiments, the data driver 150 and the controller 160 may be implemented as a single integrated circuit, and the single integrated circuit may be referred to as a timing controller embedded data driver (“TED”) integrated circuit. In other embodiments, the data driver 150 and the controller 160 may be implemented as separate integrated circuits.

The controller 160 (e.g., a timing controller) may receive input image data IDAT and a control signal CTRL from a processor (e.g., an application processor (“AP”), a graphics processing unit (“GPU”), a graphics card, etc.). The input image data IDAT may be image data suitable for a second pixel arrangement structure different from the first pixel arrangement structure. In some embodiments, the second pixel arrangement structure may be a stripe pixel arrangement structure in which each subpixel includes one first color subpixel, one second color subpixel, and one third color subpixel, which are sequentially arranged in one direction, and the input image data IDAT may be RGB stripe image data including a plurality of red subpixel data, a plurality of green subpixel data and a plurality of blue subpixel data. Even though the stripe pixel arrangement structure is not shown in the figures, in an embodiment, the stripe pixel arrangement structure may have the same arrangement of pixels corresponding to the input image data shown in the FIG. 5. The control signal CTRL may include a mode signal SMODE indicating a mode of the display device 100. For example, the mode signal SMODE may indicate, but is not limited to, a normal mode or a private mode. In some embodiments, the control signal CTRL may further include, but is not limited to, a vertical synchronization signal, a horizontal synchronization signal, an input data enable signal, a master clock signal, etc. The controller 160 may generate the data control signal DCTRL, the scan control signal SCTRL, the emission control signal EMCTRL and the output image data ODAT1/ODAT2 based on the control signal CTRL and the input image data IDAT. The controller 160 may control the scan driver 130 by providing the scan control signal SCTRL to the scan driver 130, may control the emission driver 140 by providing the emission control signal EMCTRL to the emission driver 140, and may control the data driver 150 by providing the output image data ODAT1/ODAT2 and the data control signal DCTRL to the data driver 150.

The display device 100 according to embodiments may display an image to both of the first user positioned in front of the display device 100 and the second user positioned on the side of the display device 100 in the normal mode. However, in the private mode, the display device 100 according to embodiments may display an image to the first user positioned in front of the display device 100, but not to the second user positioned on the side of the display device 100.

In some embodiments, in the normal mode, as illustrated in FIG. 3A, the panel driver 120 may drive the plurality of normal subpixels NSP and the plurality of private subpixels PSP such that the plurality of normal subpixels NSP having the relatively wide viewing angle, or the normal red subpixels NRSP, the normal green subpixels NGSP and the normal blue subpixels NBSP emit light, and the plurality of private subpixels PSP having the relatively narrow viewing angle, or the private red subpixels PRSP, the private green subpixels PGSP and the private blue subpixels PBSP emit light. For example, the controller 160 of the panel driver 120 may provide the data driver 150 with first output image data ODAT1 for the plurality of normal subpixels NSP and the plurality of private subpixels PSP, the data driver 150 may provide the data signals DS to the plurality of normal subpixels NSP and the plurality of private subpixels PSP based on the first output image data ODAT1, and the plurality of normal subpixels NSP and the plurality of private subpixels PSP may emit light based on the data signals DS. Thus, an image displayed by the display device 100 may be viewed by both of the first user positioned in front of the display device 100 and the second user positioned on the side of the display device 100.

In other embodiments, in the normal mode, as illustrated in FIG. 3B, the panel driver 120 may drive only the plurality of normal subpixels NSP such that the plurality of normal subpixels NSP having the relatively wide viewing angle, or the normal red subpixels NRSP, the normal green subpixels NGSP and the normal blue subpixels NBSP emit light, and the plurality of private subpixels PSP do not emit light. For example, the controller 160 of the panel driver 120 may provide first output image data ODAT1 for the plurality of normal subpixels NSP to the data driver 150, the data driver 150 may provide the data signals DS to the plurality of normal subpixels NSP based on the first output image data ODAT1, and the plurality of normal subpixels NSP may emit light based on the data signals DS. Since the plurality of normal subpixels NSP having the relatively wide viewing angle emit light, an image displayed by the display device 100 may be viewed by both of the first user positioned in front of the display device 100 and the second user positioned on the side of the display device 100. In this case, the first output image data ODAT1 may represent the minimum gray level (e.g., a 0-gray level) with respect to the plurality of private subpixels PSP, and the data driver 150 may not provide the data signals DS to the plurality of private subpixels PSP or may provide the data signals DS corresponding to the minimum gray level. Thus, the plurality of private subpixels PSP may not emit light.

Further, in the private mode, as illustrated in FIG. 4, the panel driver 120 may drive only the plurality of private subpixels PSP such that the plurality of normal subpixels NSP having the relatively wide viewing angle do not emit light, and the plurality of private subpixels PSP having the relatively narrow viewing angle, or the private red subpixels PRSP, the private green subpixels PGSP and the private blue subpixels PBSP emit light. For example, the controller 160 of the panel driver 120 may provide second output image data ODAT2 for the plurality of private subpixels PSP to the data driver 150, the data driver 150 may provide the data signals DS to the plurality of private subpixels PSP based on the second output image data ODAT2, and the plurality of private subpixels PSP may emit light based on the data signals DS. In this case, since only the plurality of private subpixels PSP having the relatively narrow viewing angle emit light, an image displayed by the display device 100 may be viewed by the first user positioned in front of the display device 100, but may not be viewed by the second user positioned on the side of the display device 100. In this case, the second output image data ODAT2 may represent the minimum gray level with respect to the plurality of normal subpixels NSP, and the data driver 150 may not provide the data signals DS to the plurality of normal subpixels NSP or may provide the data signals DS corresponding to the minimum gray level. Thus, the plurality of normal subpixels NSP may not emit light.

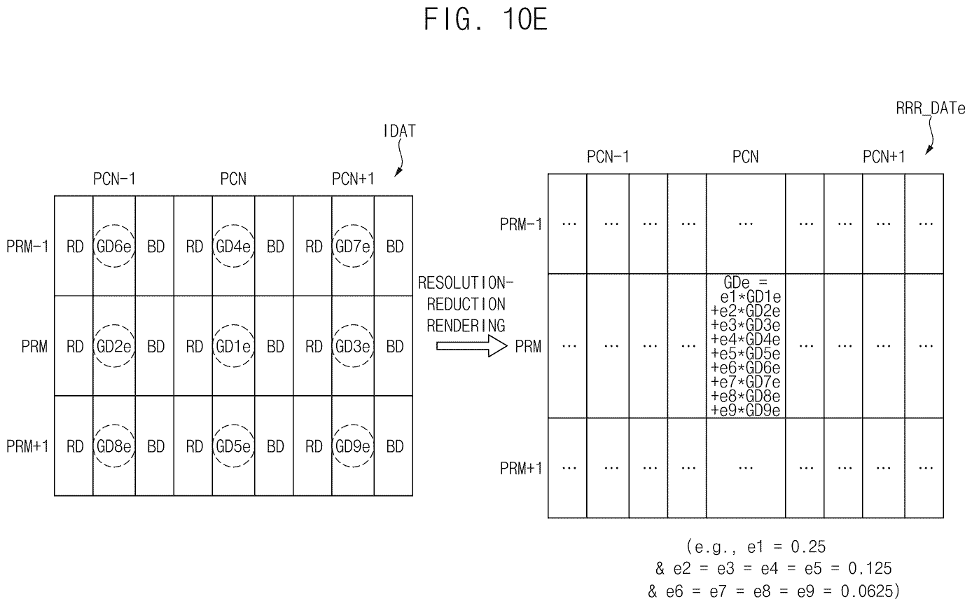

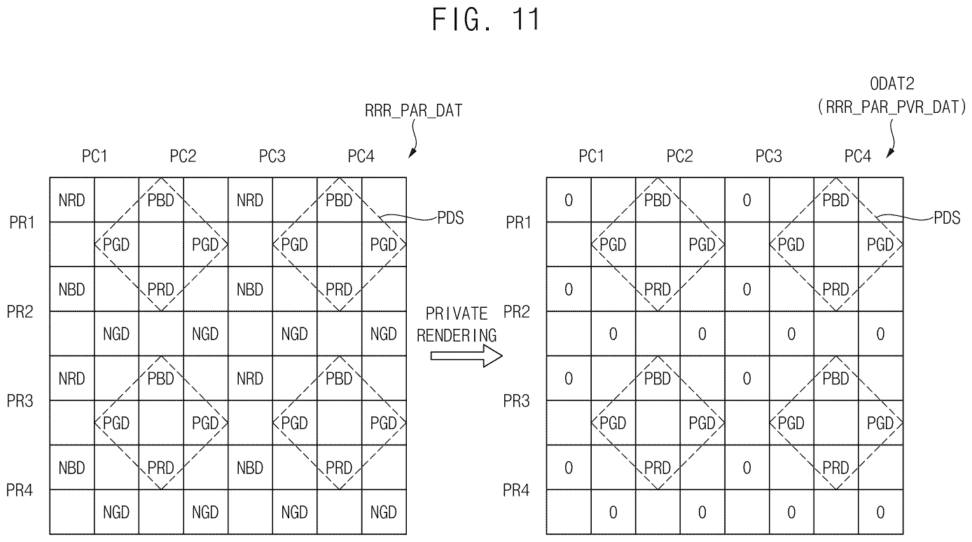

However, in the private mode in which only the plurality of private subpixels PSP are driven (and/or in the normal mode in which only the plurality of normal subpixels NSP are driven as illustrated in FIG. 3B), in a case where only a conventional rendering operation is performed on the input image data IDAT, a color shift phenomenon (e.g., a reddish color shift phenomenon and/or a greenish color shift phenomenon) may occur in the image displayed by the display device 100. For example, as illustrated in FIG. 5, the input image data IDAT may include red, green and blue subpixel data RD, GD and BD representing the minimum gray level, or the 0-gray level with respect to odd-numbered pixel rows PR1 and PR3, and may include red, green and blue subpixel data RD, GD and BD representing the maximum gray level, or a 255-gray level with respect to even-numbered pixel rows PR2 and PR4. A conventional display device may perform a pixel arrangement rendering operation on the input image data IDAT illustrated in FIG. 5 to generate image data PAR_DAT illustrated in FIG. 6A. Here, as described below with reference to FIG. 9, the pixel arrangement rendering operation may convert image data (as shown in FIG. 5) corresponding to the second pixel arrangement structure (e.g., the stripe pixel arrangement structure) into image data corresponding to the first pixel arrangement structure (e.g., the DIAMOND PIXEL® arrangement structure). Further, in the private mode, the conventional display device may perform a private rendering operation on the image data PAR_DAT on which the pixel arrangement rendering operation is performed to generate image data PAR_PVR_DAT illustrated in FIG. 6B. Here, as described below with reference to FIG. 11, the private rendering operation may convert subpixel data for the plurality of normal subpixels NSP into minimum level data representing the minimum gray level (e.g., the 0-gray level). That is, in the conventional display device, the image data PAR_PVR_DAT generated by performing the pixel arrangement rendering operation and the private rendering operation on the input image data IDAT corresponding to a black-and-white image illustrated in FIG. 5 may include green and blue subpixel data GD and BD representing the minimum gray level (e.g., the 0-gray level) and red subpixel data RD representing the maximum gray level (e.g., the 255-gray level). In this case, the conventional display device may display a red image based on the image data PAR_PVR_DAT illustrated in FIG. 6B. That is, the color shift phenomenon (e.g., the reddish color shift phenomenon) may occur in the image displayed by the conventional display device.

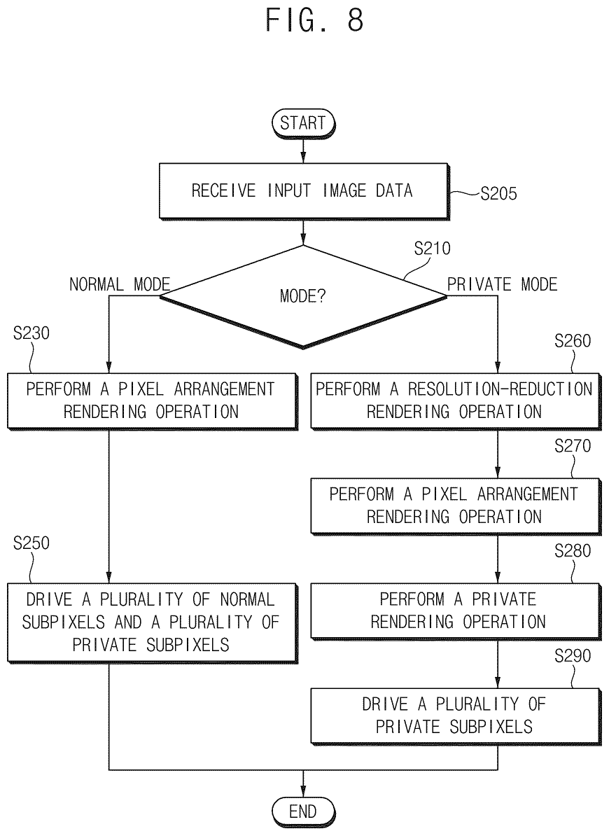

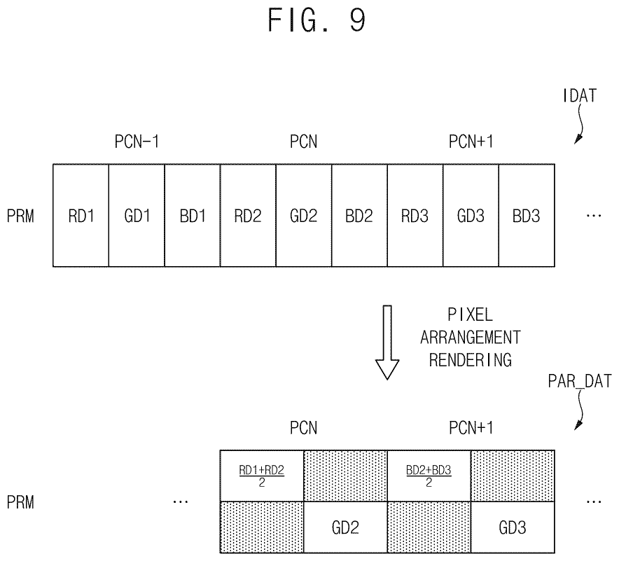

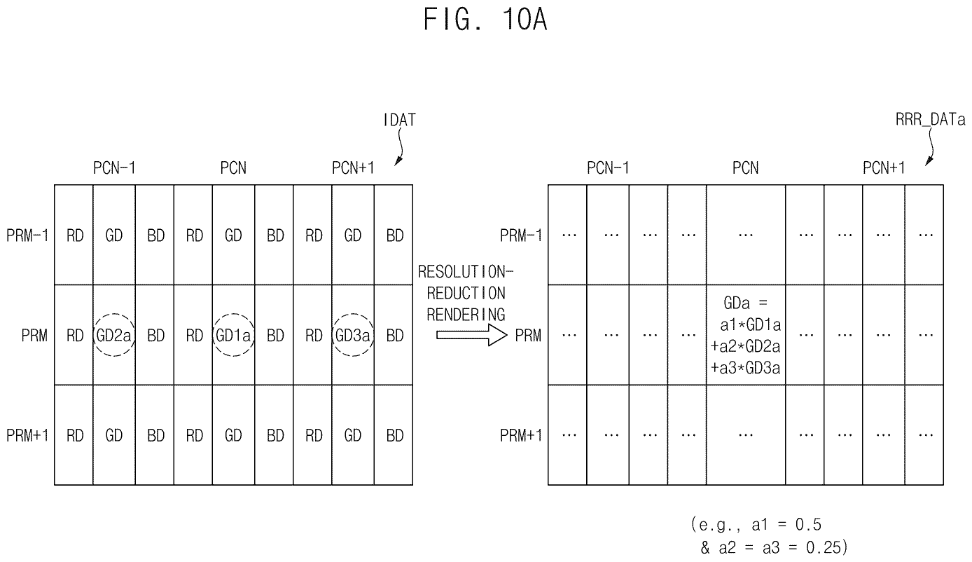

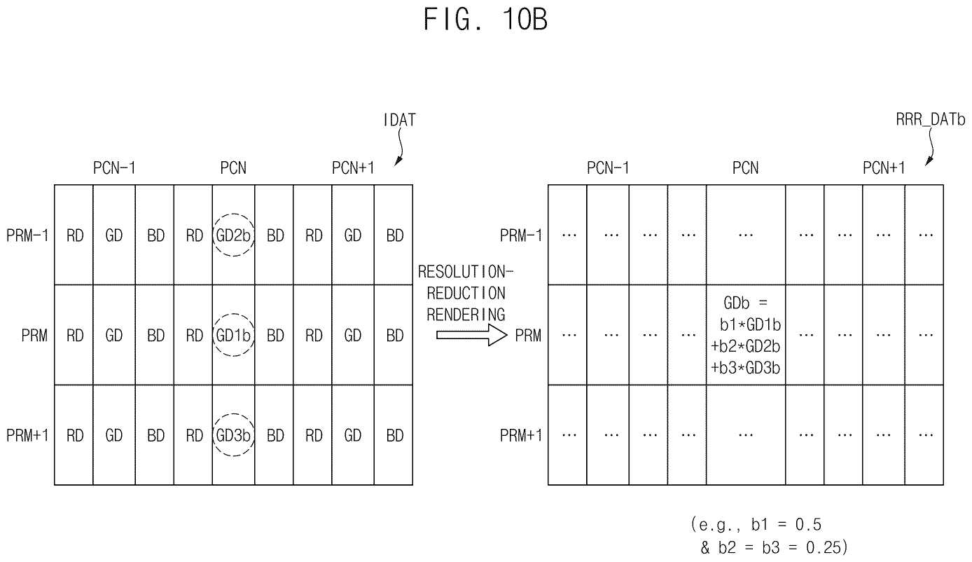

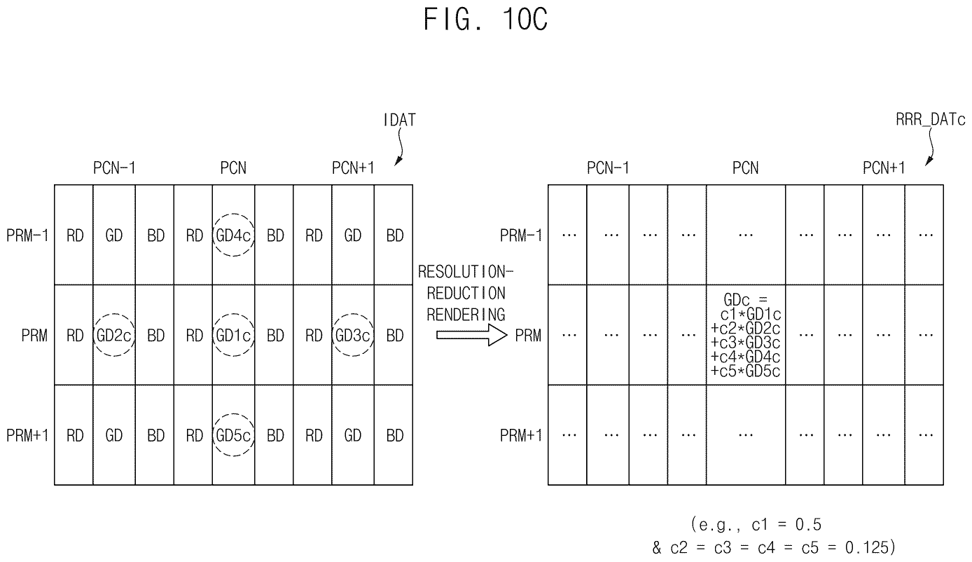

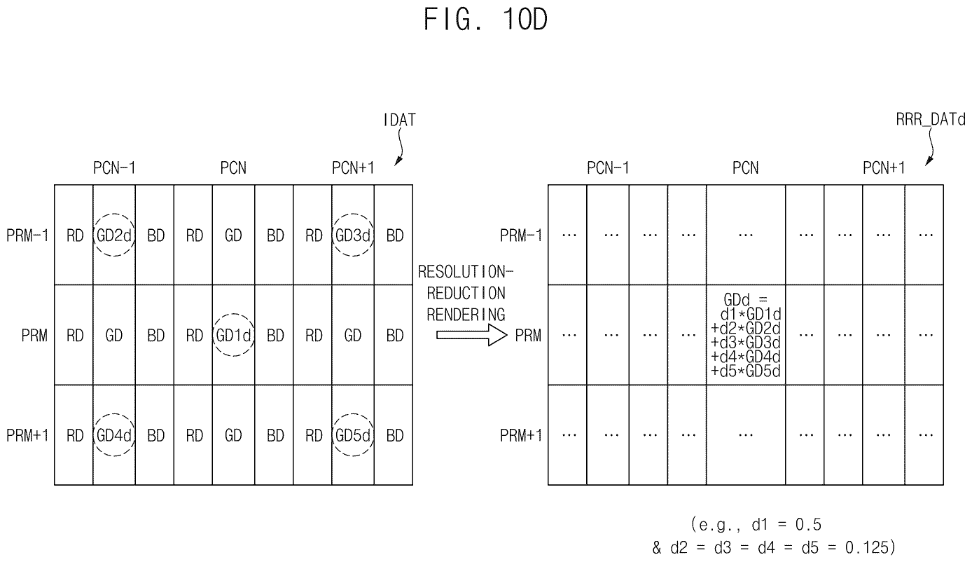

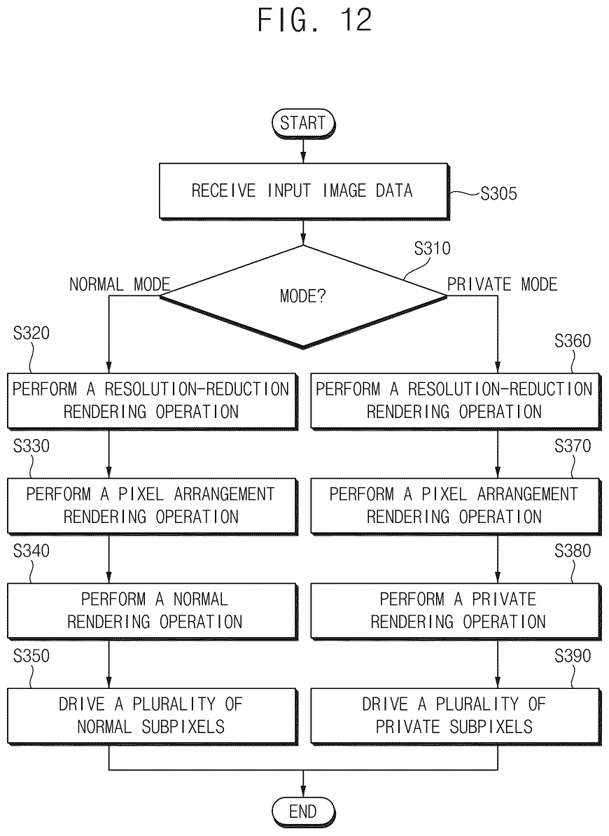

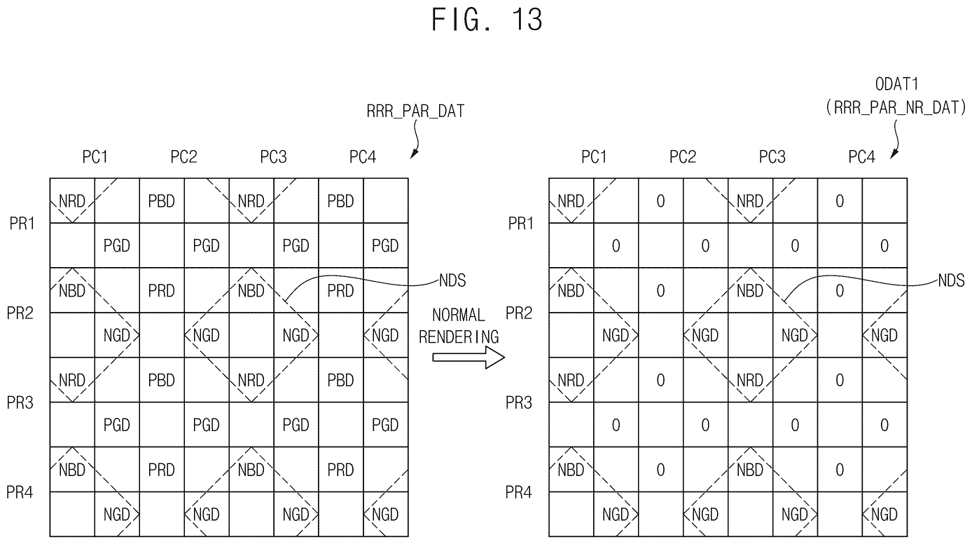

However, to prevent or reduce the color shift phenomenon, the display device 100 according to embodiments may perform a resolution-reduction rendering operation on the input image data IDAT. Here, as described below with reference to FIGS. 10A through 10E, the resolution-reduction rendering operation may adjust each subpixel data included in the input image data IDAT based on adjacent subpixel data. In some embodiments, as described below with reference to FIGS. 8 through 11, the controller 160 of the panel driver 120 may generate first output image data ODAT1 by performing the pixel arrangement rendering operation on the input image data IDAT in the normal mode, and may generate second output image data ODAT2 by performing the resolution-reduction rendering operation, the pixel arrangement rendering operation and the private rendering operation on the input image data IDAT in the private mode. In other embodiments, as described below with reference to FIGS. 12 and 13, the controller 160 of the panel driver 120 may generate first output image data ODAT1 by performing the resolution-reduction rendering operation, the pixel arrangement rendering operation and a normal rendering operation on the input image data IDAT in the normal mode, and may generate second output image data ODAT2 by performing the resolution-reduction rendering operation, the pixel arrangement rendering operation and the private rendering operation on the input image data IDAT in the private mode. In these operations, in some embodiments, the controller 160 of the panel driver 120 may include a resolution-reduction rendering block 170, a pixel arrangement rendering block 180 and a mode rendering block 190.

The resolution-reduction rendering block 170 may perform the resolution-reduction rendering operation that adjusts each subpixel data included in the input image data IDAT based on adjacent subpixel data in the private mode. According to embodiments, the resolution-reduction rendering operation may adjust each subpixel data based on two horizontally adjacent subpixel data as described below with reference to FIG. 10A, based on two vertically adjacent subpixel data as described below with reference to FIG. 10B, based on four horizontally and vertically adjacent subpixel data as described below with reference to FIG. 10C, based on four diagonally adjacent subpixel data as described below with reference to FIG. 10D, or based on eight adjacent subpixel data as described below with reference to FIG. 10E. For example, the resolution-reduction rendering block 170 may perform the resolution-reduction rendering operation illustrated in FIG. 10E on each subpixel data RD, GD and BD of the input image data IDAT illustrated in FIG. 5 to generate image data RRR_DAT illustrated in FIG. 7A. The image data RRR_DAT on which the above resolution-reduction rendering operation is performed may include red, green and blue subpixel data RD, GD and BD representing a 128-gray level, a 96-gray level or a 48-gray level. In embodiments described below with reference to FIGS. 12 and 13, the resolution-reduction rendering block 170 may perform the resolution-reduction rendering operation on the input image data IDAT not only in the private mode but also in the normal mode.

The pixel arrangement rendering block 180 may perform the pixel arrangement rendering operation in the normal mode and the private mode. The pixel arrangement rendering operation may convert image data corresponding to the second pixel arrangement structure (e.g., the stripe pixel arrangement structure) into image data corresponding to the first pixel arrangement structure (e.g., the DIAMOND PIXEL® arrangement structure). In some embodiments, the pixel arrangement rendering operation may be referred to as a PENTILE® rendering operation. In embodiments described below with reference to FIGS. 8 through 11, the pixel arrangement rendering block 180 may perform the pixel arrangement rendering operation on the input image data IDAT in the normal mode, and may perform the pixel arrangement rendering operation on the image data RRR_DAT on which the resolution-reduction rendering operation is performed in the private mode. For example, in the private mode, the pixel arrangement rendering block 180 may perform the pixel arrangement rendering operation on the image data RRR_DAT illustrated in FIG. 7A to generate the image data RRR_PAR_DAT illustrated in FIG. 7B. The image data RRR_PAR_DAT on which the resolution-reduction rendering operation and the pixel arrangement rendering operation are performed may be suitable for the first pixel arrangement structure of the display panel 110 illustrated in FIG. 2, or the DIAMOND PIXEL® arrangement structure, and may include red subpixel data RD representing a 24-gray level, a 48-gray level, a 112-gray level or a 128-gray level, green subpixel data GD representing a 48-gray level, a 64-gray level, a 96-gray level or a 128-gray level, and blue subpixel data BD representing a 48-gray level, a 56-gray level or a 112-gray level. In embodiments described below with reference to FIGS. 12 and 13, the pixel arrangement rendering block 180 may perform the pixel arrangement rendering operation on the image data RRR_DAT on which the resolution-reduction rendering operation is performed in both of the normal mode and the private mode.

The mode rendering block 190 may generate the second output image data ODAT2 by performing the private rendering operation on the image data RRR_PAR_DAT on which the resolution-reduction rendering operation and the pixel arrangement rendering operation are performed in the private mode. The private rendering operation may convert subpixel data for the plurality of normal subpixels NSP among subpixel data included in the image data RRR_PAR_DAT on which the resolution-reduction rendering operation and the pixel arrangement rendering operation are performed into the minimum level data representing the minimum gray level (e.g., the 0-gray level). For example, in the private mode, the mode rendering block 190 may perform the private rendering operation on the image data RRR_PAR_DAT illustrated in FIG. 7B to generate image data RRR_PAR_PVR_DAT illustrated in FIG. 7C, or the second output image data ODAT2 for the plurality of private subpixels PSP. As illustrated in FIG. 7C, the image data RRR_PAR_PVR_DAT on which the resolution-reduction rendering operation, the pixel arrangement rendering operation and the private rendering operation are performed may include red, green and blue subpixel data RD, GD and BD representing the 0-gray level with respect to the plurality of normal subpixels NSP, and may include red, green and blue subpixel data RD, GD and BD representing a 48-gray level, a 56-gray level, a 64-gray level, a 96-gray level, a 112-gray level or a 128-gray level with respect to the plurality of private subpixels PSP arranged in the diamond shape PDS. Thus, unlike the image data PAR_PVR_DAT illustrated in FIG. 6B in which all the green and blue subpixel data GD and BD represent the 0-gray level, the image data RRR_PAR_PVR_DAT illustrated in FIG. 7C may include the green and blue subpixel data GD and BD representing the 48-gray level, the 56-gray level, the 64-gray level, the 96-gray level, the 112-gray level or the 128-gray level with respect to the plurality of private subpixels PSP. Accordingly, in the display device 100 according to embodiments, the color shift phenomenon (e.g., the red color shift phenomenon and/or the green color shift phenomenon) may be prevented or reduced even in the private mode. In embodiments described below with reference to FIGS. 12 and 13, the mode rendering block 190 may perform the normal rendering operation that converts subpixel data for the plurality of private subpixels PSP into the minimum level data representing the minimum gray level with respect to the image data RRR_PAR_DAT on which the resolution-reduction rendering operation and the pixel arrangement rendering operation are performed in the normal mode.

As described above, the display device 100 according to embodiments may perform the resolution-reduction rendering operation on the input image data IDAT. Accordingly, in the display device 100 according to embodiments, the color shift phenomenon may be prevented or reduced in the private mode and/or the normal mode.

FIG. 8 is a flowchart illustrating a method of operating a display device according to embodiments, FIG. 9 is a diagram for describing an example of a pixel arrangement rendering operation according to embodiments, FIGS. 10A through 10E are diagrams for describing examples of a resolution-reduction rendering operation according to embodiments, and FIG. 11 is a diagram for describing an example of a private rendering operation according to embodiments.

Referring to FIGS. 1 and 8, a panel driver 120 of a display device 100 may receive input image data IDAT corresponding to a stripe pixel arrangement structure (S205). When a mode of the display device 100 is a normal mode, or when the mode signal SMODE indicates the normal mode (S210: NORMAL MODE), the panel driver 120 may perform a pixel arrangement rendering operation on the input image data IDAT corresponding to the stripe pixel arrangement structure to generate first output image data ODAT1 corresponding to a DIAMOND PIXEL® arrangement structure (S230).

In some embodiments, the pixel arrangement rendering operation may generate subpixel data for a normal or private red subpixel based on two adjacent red subpixel data included in the input image data IDAT, may determine each green subpixel data included in the input image data IDAT as subpixel data for a normal or private green subpixel, and generate subpixel data for a normal or private blue subpixel based on two adjacent blue subpixel data included in the input image data IDAT. For example, as illustrated in FIG. 9, the input image data IDAT may include first red, green and blue subpixel data RD1, GD1 and BD1 for a pixel positioned in an M-th pixel row PRM and an (N−1)-th pixel column PCN-1, where M is an integer greater than or equal to 1 and N is an integer greater than or equal to 2, second red, green and blue subpixel data RD2, GD2 and BD2 for a pixel positioned in the M-th pixel row PRM and an N-th pixel column PCN, and third red, green and blue subpixel data RD3, GD3 and BD3 for a pixel positioned in the M-th pixel row PRM and an (N+1)-th pixel column PCN+1. The panel driver 120 may perform the pixel arrangement rendering operation on the input image data IDAT to generate image data PAR_DAT. In the display panel 110, in a case where the pixel positioned in the M-th pixel row PRM and the N-th pixel column PCN includes a (normal or private) red subpixel and a (normal or private) green subpixel, the image data PAR_DAT on which the pixel arrangement rendering operation is performed may correspond to half of a sum of the first red subpixel data RD1 and the second red subpixel data RD2 with respect to the red subpixel, and may correspond to the second green subpixel data GD2 with respect to the green subpixel. Further, in the display panel 110, in a case where the pixel positioned in the M-th pixel row PRM and the (N+1)-th pixel column PCN+1 includes a (normal or private) blue subpixel and a (normal or private) green subpixel, the image data PAR_DAT on which the pixel arrangement rendering operation is performed may correspond to half of a sum of the second blue subpixel data BD2 and the third blue subpixel data BD3 with respect to the blue subpixel, and may correspond to the third green subpixel data GD3 with respect to the green subpixel. Although an example of the pixel arrangement rendering operation is illustrated in FIG. 9, the pixel arrangement rendering operation according to embodiments is not limited to the example of FIG. 9.

The panel driver 120 may drive a plurality of normal subpixels NSP having a relatively wide viewing angle and a plurality of private subpixels PSP having a relatively narrow viewing angle based on the first output image data ODAT1 generated by performing the pixel arrangement rendering operation on the input image data IDAT (S250). Thus, an image displayed in the normal mode may be viewed by both of a first user positioned in front of the display device 100 and a second user positioned on the side of the display device 100.

When the mode of the display device 100 is a private mode, or when the mode signal SMODE indicates the private mode (S210: PRIVATE MODE), the panel driver 120 may perform a resolution-reduction rendering operation that adjusts each subpixel data included in the input image data IDAT based on adjacent subpixel data (S260). By the resolution-reduction rendering operation, each subpixel data may be adjusted to intermediate values, and an image may be blurred. Thus, the resolution-reduction rendering operation may have, but is not limited to, an effect of reducing a resolution of the image.

In some embodiments, in the resolution-reduction rendering operation, the panel driver 120 may adjust each red subpixel data based on two red subpixel data horizontally adjacent to the each red subpixel data included in the input image data IDAT, may adjust each green subpixel data based on two green subpixel data horizontally adjacent to the each green subpixel data included in the input image data IDAT, and may adjust each blue subpixel data based on two blue subpixel data horizontally adjacent to the each blue subpixel data included in the input image data IDAT. For example, as illustrated in FIG. 10A, the panel driver 120 may perform the resolution-reduction rendering operation on the input image data IDAT to generate image data RRR_DATa, and green subpixel data GDa included in the image data RRR_DATa may be calculated as “a1*GD1a+a2*GD2a+a3*GD3a”. Here, a1, a2 and a3 are coefficients, and GD1a, GD2a and GD3a may be green subpixel data included in the input image data IDAT. Further, for example, a1 may be, but is not limited to, about 0.5, and each of a2 and a3 may be, but is not limited to, about 0.25. Thus, by the resolution-reduction rendering operation, the green subpixel data GD1a in the M-th pixel row PRM and the N-th pixel column PCN may be adjusted to the green subpixel data GDa, or “0.5*GD1a+0.25*GD2a+0.25*GD3a” based on two green subpixel data GD2a and GD3a horizontally adjacent to the green subpixel data GD1a. Although FIG. 10A illustrates an example in which the green subpixel data GD1a is adjusted, red or blue subpixel data RD and BD also may be adjusted based on horizontally adjacent red or blue subpixel data by the resolution-reduction rendering operation.

In other embodiments, in the resolution-reduction rendering operation, the panel driver 120 may adjust each red subpixel data based on two red subpixel data vertically adjacent to the each red subpixel data included in the input image data IDAT, may adjust each green subpixel data based on two green subpixel data vertically adjacent to the each green subpixel data included in the input image data IDAT, and may adjust each blue subpixel data based on two blue subpixel data vertically adjacent to the each blue subpixel data included in the input image data IDAT. For example, as illustrated in FIG. 10B, the panel driver 120 may perform the resolution-reduction rendering operation on the input image data IDAT to generate image data RRR_DATb, and green subpixel data GDb included in the image data RRR_DATb may be calculated as “b1*GD1b+b2*GD2b+b3*GD3b”. Here, b1, b2, and b3 may be coefficients, and GD1b, GD2b and GD3b may be green subpixel data included in the input image data IDAT. Further, for example, b1 may be, but is not limited to, about 0.5, and each of b2 and b3 may be, but is not limited to, about 0.25. Thus, by the resolution-reduction rendering operation, the green subpixel data GD1b in the M-th pixel row PRM and the N-th pixel column PCN may be adjusted to the green subpixel data GDb, or “0.5*GD1b+0.25*GD2b+0.25*GD3b” based on two green subpixels GD2b and GD3b vertically adjacent to the green subpixel data GD1b. Although FIG. 10B illustrates an example in which the green subpixel data GD1a is adjusted, red or blue subpixel data RD and BD also may be adjusted based on vertically adjacent red or blue subpixel data by the resolution-reduction rendering operation.

In still other embodiments, in the resolution-reduction rendering operation, the panel driver 120 may adjust each red subpixel data based on four red subpixel data horizontally and vertically adjacent to the each red subpixel data included in the input image data IDAT, may adjust each green subpixel data based on four green subpixel data horizontally and vertically adjacent to the each green subpixel data included in the input image data IDAT, and may adjust each blue subpixel data based on four blue subpixel data horizontally and vertically adjacent to the each blue subpixel data included in the input image data IDAT. For example, as illustrated in FIG. 10C, the panel driver 120 may perform the resolution-reduction rendering operation on the input image data IDAT to generate image data RRR_DATc, and green subpixel data GDc included in the image data RRR_DATc may be calculated as “c1*GD1c+c2*GD2c+c3*GD3c+c4*GD4c+c5*GD5c”. Here, c1, c2, c3, c4 and c5 are coefficients, and GD1c, GD2c, GD3c, GD4c and GD5c may be green subpixel data included in the input image data IDAT. Further, for example, c1 may be, but is not limited to, about 0.5, and each of c2, c3, c4 and c5 may be, but is not limited to, about 0.125. Thus, by the resolution-reduction rendering operation, the green subpixel data GD1c in the M-th pixel row PRM and the N-th pixel column PCN may be adjusted to the green subpixel data GDc, or “c1*GD1c+c2*GD2c+c3*GD3c+c4*GD4c+c5*GD5c” based on four green subpixels GD2c, GD3c, GD4c and GD5c horizontally and vertically adjacent to the green subpixel data GD1c. Although FIG. 10C illustrates an example in which the green subpixel data GD1c is adjusted, red or blue subpixel data RD and BD also may be adjusted based on horizontally and vertically adjacent red or blue subpixel data by the resolution-reduction rendering operation.

In still other embodiments, in the resolution-reduction rendering operation, the panel driver 120 may adjust each red subpixel data based on four red subpixel data diagonally adjacent to the each red subpixel data included in the input image data IDAT, may adjust each green subpixel data based on four green subpixel data diagonally adjacent to the each green subpixel data included in the input image data IDAT, and may adjust each blue subpixel data based on four blue subpixel data diagonally adjacent to the each blue subpixel data included in the input image data IDAT. For example, as illustrated in FIG. 10D, the panel driver 120 may perform the resolution-reduction rendering operation on the input image data IDAT to generate image data RRR_DATd, and green subpixel data GDd included in the image data RRR_DATd may be calculated as “d1*GD1d+d2*GD2d+d3*GD3d+d4*GD4d+d5*GD5d”. Here, d1, d2, d3, d4 and d5 may be coefficients, and GD1d, GD2d, GD3d, GD4d and GD5d may be green subpixel data included in the input image data IDAT. Further, for example, d1 may be, but is not limited to, about 0.5, and each of d2, d3, d4 and d5 may be, but is not limited to, about 0.125. Thus, by the resolution-reduction rendering operation, the green subpixel data GD1d in the M-th pixel row PRM and the N-th pixel column PCN may be adjusted to the green subpixel data GDd, or “d1*GD1d+d2*GD2d+d3*GD3d+d4*GD4d+d5*GD5d” based on green subpixels GD2d, GD3d, GD4d and GD5d diagonally adjacent to the green subpixel data GD1d. Although FIG. 10D illustrates an example in which the green subpixel data GD1d is adjusted, red or blue subpixel data RD and BD also may be adjusted based on diagonally adjacent red or blue subpixel data by the resolution-reduction rendering operation.

In still other embodiments, in the resolution-reduction rendering operation, the panel driver 120 may adjust each red subpixel data based on eight red subpixel data horizontally, vertically and diagonally adjacent to the each red subpixel data included in the input image data IDAT, may adjust each green subpixel data based on eight green subpixel data horizontally, vertically and diagonally adjacent to the each green subpixel data included in the input image data IDAT, and may adjust each blue subpixel data based on eight blue subpixel data horizontally, vertically and diagonally adjacent to the each blue subpixel data included in the input image data IDAT. For example, as illustrated in FIG. 10E, the panel driver 120 may perform the resolution-reduction rendering operation on the input image data IDAT to generate image data RRR_DATe, and green subpixel data GDe included in the image data RRR_DATe may be calculated as “e1*GD1e+e2*GD2e+e3*GD3e+e4*GD4e+e5*GD5e+e6*GD6e+e7*GD7e+e8*GD8e+e9*GD9e”. Here, e1, e2, e3, e4, e5, e6, e7, e8 and e9 may be coefficients, and GD1e, GD2e, GD3e, GD4e, GD5e, GD6e, GD7e, GD8e and GD9e may be green subpixel data included in the input image data IDAT. Further, for example, e1 may be, but is not limited to, about 0.25, each of e2, e3, e4 and e5 may be, but is not limited to, about 0.125, and each of e6, e7, e8 and e9 may be, but is not limited to, about 0.0625. Thus, by the resolution-reduction rendering operation, the green subpixel data GD1e in the M-th pixel row PRM and the N-th pixel column PCN may be adjusted to the green subpixel data GDe, or “e1*GD1e+e2*GD2e+e3*GD3e+e4*GD4e+e5*GD5e+e6*GD6e+e7*GD7e+e8*GD8e+e9*GD9e” based on eight green subpixels GD2e, GD3e, GD4e, GD5e, GD6e, GD7e, GD8e and GD9e horizontally, vertically and diagonally adjacent to the green subpixel data GD1e. Although FIG. 10E illustrates an example in which the green subpixel data GD1e is adjusted, red or blue subpixel data RD and BD also may be adjusted based on horizontally, vertically and diagonally adjacent red or blue subpixel data by the resolution-reduction rendering operation.

The panel driver 120 may perform the pixel arrangement rendering operation on the image data RRR_DATa, RRR_DATb, RRR_DATc, RRR_DATd and RRR_DATe on which the resolution-reduction rendering operation is performed (S270), and may generate second output image data ODAT2 by performing a private rendering operation on the image data RRR_PAR_DAT on which the resolution-reduction rendering operation and the pixel arrangement rendering operation are performed as illustrated in FIG. 11 (S280).

For example, as illustrated in FIG. 11, the image data RRR_PAR_DAT on which the resolution-reduction rendering operation and the pixel arrangement rendering operation are performed may include normal red, green and blue subpixel data NRD, NGD and NBD for normal red, green and blue subpixels NRSP, NGSP and NBSP illustrated in FIG. 2, and private red, green and blue subpixel data PRD, PGD and PBD for private red, green and blue subpixels PRSP, PGSP and PBSP illustrated in FIG. 2. The panel driver 120 may perform the private rendering operation that converts the normal red, green and blue subpixel data NRD, NGD and NBD included in the image data RRR_PAR_DAT into minimum level data representing the minimum gray level, or a 0-gray level, to generate the second output image data ODAT2. Thus, the second output image data ODAT2, or the image data RRR_PAR_PVR_DAT on which the resolution-reduction rendering operation, the pixel arrangement rendering operation and the private rendering operation are performed, may include the private red, green and blue subpixel data PRD, PGD and PBD for the private red, green and blue subpixels PRSP, PGSP and PBSP arranged in the diamond shape PDS, but may represent the 0-gray level with respect to the normal red, green and blue subpixels NRSP, NGSP and NBSP.

The panel driver 120 may drive the plurality of private subpixels PSP having the relatively narrow viewing angle based on the second output image data ODAT2 generated by performing the resolution-reduction rendering operation, the pixel arrangement rendering operation and the private rendering operation on the input image data IDAT (S290). Thus, the plurality of private subpixels PSP having the relatively narrow viewing angle may emit light. However, since the second output image data ODAT2 represent the 0-gray level with respect to the plurality of normal subpixels NSP having the relatively wide viewing angle, the plurality of normal subpixels NSP having the relatively wide viewing angle may not emit light. Thus, an image displayed in the private mode may be viewed by the first user positioned in front of the display device 100, but may not be viewed by the second user positioned on the side of the display device 100.

As described above, in the method of operating the display device 100 according to embodiments, the resolution-reduction rendering operation may be performed on the input image data IDAT in the private mode. Accordingly, a color shift phenomenon may be prevented or reduced in the private mode.

FIG. 12 is a flowchart illustrating a method of operating a display device according to embodiments, and FIG. 13 is a diagram for describing an example of a normal rendering operation according to embodiments.

Referring to FIGS. 1 and 12, a panel driver 120 of a display device 100 may receive input image data IDAT (S305). When a mode of the display device 100 is a normal mode, or when a mode signal SMODE indicates the normal mode (S310: NORMAL MODE), the panel driver 120 may perform a resolution-reduction rendering operation that adjusts each subpixel data included in the input image data IDAT based on adjacent subpixel data (S320), may perform a pixel arrangement rendering operation on the input image data IDAT on which the resolution-reduction rendering operation is performed (S330), and may perform a normal rendering operation on the input image data IDAT on which the resolution-reduction rendering operation and the pixel arrangement rendering operation are performed to generate first output image data ODAT1 (S340). For example, the resolution-reduction rendering operation may correspond to a resolution-reduction rendering operation described above with reference to FIGS. 10A through 10E, and the pixel arrangement rendering operation may correspond to a pixel arrangement rendering operation described above with reference to FIG. 9.

For example, as illustrated in FIG. 13, image data RRR_PAR_DAT on which the resolution-reduction rendering operation and the pixel arrangement rendering operation are performed may include normal red, green and blue subpixel data NRD, NGD and NBD for normal red, green and blue subpixels NRSP, NGSP and NBSP illustrated in FIG. 2, and private red, green and blue subpixel data PRD, PGD and PBD for private red, green and blue subpixels PRSP, PGSP and PBSP illustrated in FIG. 2. The panel driver 120 may perform the normal rendering operation that converts the private red, green and blue subpixel data PRD, PGD and PBD included in the image data RRR_PAR_DAT into minimum level data representing the minimum gray level, or a 0-gray level, to generate the second output image data ODAT2. Thus, the first output image data ODAT1, or the image data RRR_PAR_NR_DAT on which the resolution-reduction rendering operation, the pixel arrangement rendering operation and the normal rendering operation are performed, may include the normal red, green and blue subpixel data NRD, NGD and NBD for the normal red, green and blue subpixels NRSP, NGSP and NBSP arranged in a diamond shape NDS, but may represent the 0-gray level with respect to the private red, green and blue subpixels PRSP, PGSP and PBSP.

The panel driver 120 may drive a plurality of normal subpixels NSP having a relatively wide viewing angle based on the first output image data ODAT1 generated by performing the resolution-reduction rendering operation, the pixel arrangement rendering operation and the normal rendering operation on the input image data IDAT (S350). Thus, the plurality of normal subpixels NSP having the relatively wide viewing angle may emit light, and an image displayed in the normal mode may be viewed by both of a first user positioned in front of the display device 100 and a second user positioned on the side of the display device 100. Since the first output image data ODAT1 represent the 0-gray level with respect to a plurality of private subpixels PSP having a relatively narrow viewing angle, the plurality of private subpixels PSP having the relatively narrow viewing angle may not emit light.

When the mode of the display device 100 is a private mode, or when the mode signal SMODE indicates the private mode (S310: PRIVATE MODE), the panel driver 120 may perform the resolution-reduction rendering operation on the input image data IDAT (S360), may performs the pixel arrangement rendering operation on the input image data IDAT on which the resolution-reduction rendering operation is performed (S370), and may perform a private rendering operation on the input image data IDAT on which the resolution-reduction rendering operation and the pixel arrangement rendering operation are performed to generate second output image data ODAT2 (S380).

The panel driver 120 may drive the plurality of private subpixels PSP having the relatively narrow viewing angle based on the second output image data ODAT2 generated by performing the resolution-reduction rendering operation, the pixel arrangement rendering operation and the private rendering operation on the input image data IDAT (S390). Thus, the plurality of private subpixels PSP having the relatively narrow viewing angle may emit light, and the plurality of normal subpixels NSP having the relatively wide viewing angle may not emit light. Accordingly, an image displayed in the private mode may be viewed by the first user positioned in front of the display device 100, but may not be viewed by the second user positioned on the side of the display device 100.

As described above, in the method of operating the display device 100 according to embodiments, the resolution-reduction rendering operation may be performed on the input image data IDAT in the normal mode and the private mode. Accordingly, a color shift phenomenon may be prevented or reduced in the normal mode and the private mode.

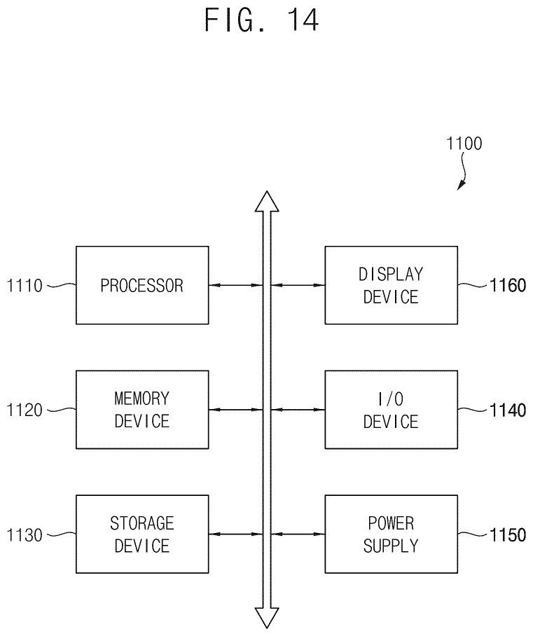

FIG. 14 is a block diagram illustrating an electronic device including a display device according to embodiments.

Referring to FIG. 14, an electronic device 1100 may include a processor 1110, a memory device 1120, a storage device 1130, an input/output (I/O) device 1140, a power supply 1150 and a display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, in some embodiments, the processor 1110 may be further coupled to an extended bus such as a peripheral component interconnection (“PCI”) bus.

The memory device 1120 may store data for operations of the electronic device 1100. For example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

The display device 1160 may receive input image data and a mode signal from the processor 1110. When the mode signal indicates a private mode, the display device 1160 may perform a resolution-reduction rendering operation, a pixel arrangement rendering operation and a private rendering operation on the input image data to generate output image data, and may drive only a plurality of private subpixels based on the output image data. Accordingly, a color shift phenomenon may be prevented or reduced in the private mode (and/or a normal mode).

The inventive concepts may be applied any electronic device 1100 including the display device 1160. For example, the inventive concepts may be applied to a mobile phone, a smart phone, a television (“TV”) (e.g., a digital TV, a three-dimensional (“3D”) TV, etc.), a virtual reality (“VR”) device, an augmented reality (“AR”) device, a mixed reality (“MR”) device, an extended reality (“XR”) device, a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

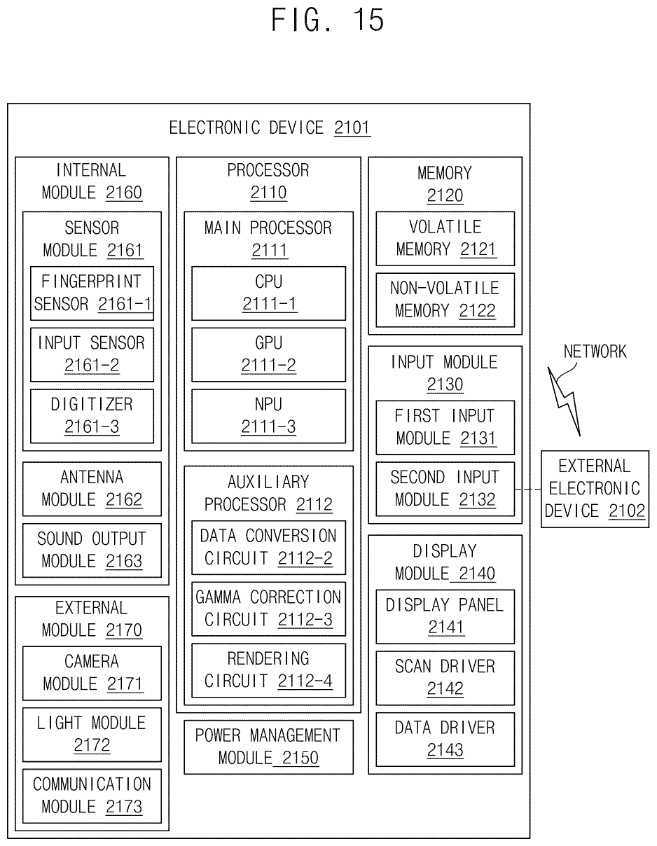

FIG. 15 is a block diagram illustrating an example of an electronic device according to embodiments.

An electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As still another example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component, or one component may be provided separately as two or more components.

Referring to FIG. 15, the electronic device 2101 may communicate with an external electronic device 2102 via a network (e.g., a short-range wireless communication network or a long-range wireless communication network). In some embodiments, the electronic device 2101 may include the processor 2110, the memory 2120, the input module 2130, the display module 2140, a power management module 2150, an internal module 2160 and an external module 2170. In some embodiments, at least one of the components may be omitted from the electronic device 2101, or one or more other components may be added in the electronic device 2101. In some embodiments, some of the components (e.g., the sensor module 2161, an antenna module 2162, or the sound output module 2163) may be implemented as a single component (e.g., the display module 2140).

The processor 2110 may execute software to control at least one other component (e.g., a hardware or software component) of the electronic device 2101 coupled with the processor 2110, and may perform various data processing or computation. According to some embodiments, as at least part of the data processing or computation, the processor 2110 may store a command or data received from another component (e.g., the input module 2130, the sensor module 2161 or a communication module 2173) in a volatile memory 2121, may process the command or the data stored in the volatile memory 2121, and may store resulting data in a non-volatile memory 2122.

The processor 2110 may include a main processor 2111 and an auxiliary processor 2112. The main processor 2111 may include one or more of a central processing unit (“CPU”) 2111-1 or an application processor (“AP”). The main processor 2111 may further include any one or more of a graphics processing unit (“GPU”) 2111-2, a communication processor (“CP”), and an image signal processor (“ISP”). The main processor 2111 may further include a neural processing unit (“NPU”) 2111-3. The NPU 2111-3 may be a processor specialized in processing an artificial intelligence model, and the artificial intelligence model may be generated through machine learning. The artificial intelligence model may include a plurality of artificial neural network layers. The artificial neural network may be a deep neural network (“DNN”), a convolutional neural network (“CNN”), a recurrent neural network (“RNN”), a restricted Boltzmann machine (“RBM”), a deep belief network (“DBN”), a bidirectional recurrent deep neural network (“BRDNN”), deep Q-network or a combination of two or more thereof, but is not limited thereto. The artificial intelligence model may, additionally or alternatively, include a software structure other than a hardware structure. At least two of the above-described processing units and processors may be implemented as an integrated component (e.g., a single chip), or respective processing units and processors may be implemented as independent components (e.g., a plurality of chips).

The auxiliary processor 2112 may include a controller. The controller included in the auxiliary processor 2112 may correspond to a controller 160 illustrated in FIG. 1. The controller may include an interface conversion circuit and a timing control circuit. The controller may receive an image signal from the main processor 2111, may convert a data format of the image signal to meet interface specifications with the display module 2140, and may output image data. The controller may output various control signals required for driving the display module 2140.

The auxiliary processor 2112 may further include a data conversion circuit 2112-2, a gamma correction circuit 2112-3, a rendering circuit 2112-4, or the like. The data conversion circuit 2112-2 may receive image data from the controller. The data conversion circuit 2112-2 may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller, and may render the image data in consideration of a pixel arrangement of the display panel 2141 in the electronic device 2101. The rendering circuit 2112-4 may include a resolution-reduction rendering block 170, a pixel arrangement rendering block 180 and a mode rendering block 190 illustrated in FIG. 1. In some embodiments, the rendering circuit 2112-4 may perform a pixel arrangement rendering operation in a normal mode, and may perform a resolution-reduction rendering operation, a pixel arrangement rendering operation and a private rendering operation in a private mode. In other embodiments, the rendering circuit 2112-4 may perform the resolution-reduction rendering operation, the pixel arrangement rendering operation and a normal rendering operation in the normal mode, and may perform the resolution-reduction rendering operation, the pixel arrangement rendering operation and the private rendering operation in the private mode. At least one of the data conversion circuit 2112-2, the gamma correction circuit 2112-3 and the rendering circuit 2112-4 may be integrated in another component (e.g., the main processor 2111 or the controller). At least one of the data conversion circuit 2112-2, the gamma correction circuit 2112-3 and the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 and the non-volatile memory 2122.

The input module 2130 may receive a command or data to be used by the components (e.g., the processor 2110, the sensor module 2161, or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In some embodiments, the second input module 2132 may include a high definition multimedia interface (“HDMI”), a universal serial bus (“USB”) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is not limited thereto. The display panel 2141 may be a rigid type display panel, or a flexible type display panel capable of being rolled or folded. The display module 2140 may further include a supporter, a bracket or a heat dissipation member that supports the display panel 2141.

The scan driver 2142 may be mounted on the display panel 2141 as a driving chip. Alternatively, the scan driver 2142 may be integrated into the display panel 2141. For example, the scan driver 2142 may include an amorphous silicon TFT gate driver circuit (“ASG”), a low temperature polycrystalline silicon (“LTPS”) TFT gate driver circuit or an oxide semiconductor TFT gate driver circuit (“OSG”) embedded in the display panel 2141. The scan driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142, or may be integrated into the scan driver 2142.

The data driver 2143 may receive a control signal from the controller, may convert image data into analog voltages (e.g., data voltages) in response to the control signal, and then may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include the emission driver, a voltage generator circuit, or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable, or a fuel cell. The power management module 2150 may include a power management integrated circuit (“PMIC”). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131, and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen, or may transmit/receive data to/from the active pen.

The input sensor 2161-2 may measure a bio-signal, such as blood pressure, moisture or body fat. For example, when a portion of the body of the user touches a sensor layer or a sensing panel, and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen, or may transmit/receive data to/from the active pen.

At least one of the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141, or at least one of the fingerprint sensor 2161-1, the input sensor 2161-2 and the digitizer 2161-3 may be disposed below the display panel 2141.

Two or more of the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. In some embodiments, the sensing panel may be disposed on the window, but the location of the sensing panel is not limited thereto.

At least one of the fingerprint sensor 2161-1, the input sensor 2161-2 and the digitizer 2161-3 may be embedded in the display panel 2141. In other words, at least one of the fingerprint sensor 2161-1, the input sensor 2161-2 and the digitizer 2161-2 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (“IR”) sensor, a biometric sensor, a temperature sensor, a humidity sensor or an illuminance sensor.

The antenna module 2162 may include one or more antennas for transmitting or receiving a signal or power to or from the outside. In some embodiments, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In some embodiments, the receiver may be implemented as separate from, or as part of the speaker. A sound output pattern of the sound output module 2163 may be integrated into the display module 2140.

The camera module 2171 may capture a still image and a moving image. In some embodiments, the camera module 2171 may include one or more lenses, an image sensor or an image signal processor. The camera module 2171 may further include an infrared camera capable of measuring the presence or absence of the user, the user's location and the user's line of sight.

The light module 2172 may provide light. The light module 2172 may include a light emitting diode or a xenon lamp. The light module 2172 may operate in conjunction with the camera module 2171, or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (“GNSS”) communication module) or a wired communication module (e.g., a local area network (“LAN”) communication module or a power line communication (“PLC”) module). The communication module 2173 may communicate with the external electronic device 2102 via a short-range communication network (e.g., Bluetooth™, wireless-fidelity (“Wi-Fi”) direct, or infrared data association (“IrDA”)) or a long-range communication network (e.g., a cellular network, the Internet or a computer network (e.g., LAN or wide area network (“WAN”))). These various types of communication modules 2173 may be implemented as a single chip, or may be implemented as multi-chips separate from each other.

The input module 2130, the sensor module 2161, the camera module 2171, and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. For example, the processor 2110 may generate image data corresponding to input data applied through a mouse or an active pen, and may output the image data to the display module 2140. Alternatively, the processor 2110 may generate command data corresponding to the input data, and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. For example, the processor 2110 may compare authentication data applied by the fingerprint sensor 2161-1 with authentication data stored in the memory 2120, and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161, and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 or the gamma correction circuit 2112-3 may perform the luminance correction on the image data, and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (“GPIO”), serial peripheral interface (“SPI”), mobile industry processor interface (“MIPI”) or ultra-path interconnect (“UPI”)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a portable communication device (e.g., a smart phone), a computer device, a portable multimedia device, a portable medical device, a camera, a wearable device and a home appliance. However, the electronic device 2101 according to embodiments is not limited to the above-described devices.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A display device comprising:
a display panel including a plurality of normal subpixels having a first viewing angle and a plurality of private subpixels having a second viewing angle different from the first viewing angle, the plurality of normal subpixels and the plurality of private subpixels being arranged in a first pixel arrangement structure; and
a panel driver, which receives input image data corresponding to a second pixel arrangement structure different from the first pixel arrangement structure, and drives the display panel,
wherein, in a normal mode, the panel driver performs a pixel arrangement rendering operation on the input image data corresponding to the second pixel arrangement structure to generate first output image data corresponding to the first pixel arrangement structure, and drives the plurality of normal subpixels and the plurality of private subpixels based on the first output image data, and
wherein, in a private mode, the panel driver performs a resolution-reduction rendering operation, which adjusts each subpixel data included in the input image data based on adjacent subpixel data included in the input image data, performs the pixel arrangement rendering operation on the input image data on which the resolution-reduction rendering operation is performed, performs a private rendering operation on the input image data on which the resolution-reduction rendering operation and the pixel arrangement rendering operation are performed to generate second output image data, and drives only the plurality of private subpixels among the plurality of normal subpixels and the plurality of private subpixels based on the second output image data.

2. The display device of claim 1, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data horizontally adjacent to the each red subpixel data among the plurality of red subpixel data in the second pixel arrangement structure, adjusts each green subpixel data based on two green subpixel data horizontally adjacent to the each green subpixel data among the plurality of green subpixel data in the second pixel arrangement structure, and adjusts each blue subpixel data based on two blue subpixel data horizontally adjacent to the each blue subpixel data among the plurality of blue subpixel data in the second pixel arrangement structure.

3. The display device of claim 1, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data vertically adjacent to the each red subpixel data among the plurality of red subpixel data in the second pixel arrangement structure, adjusts each green subpixel data based on two green subpixel data vertically adjacent to the each green subpixel data among the plurality of green subpixel data in the second pixel arrangement structure, and adjusts each blue subpixel data based on two blue subpixel data vertically adjacent to the each blue subpixel data among the plurality of blue subpixel data in the second pixel arrangement structure.

4. The display device of claim 1, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data horizontally adjacent to the each red subpixel data and two red subpixel data vertically adjacent to the each red subpixel data among the plurality of red subpixel data in the second pixel arrangement structure, adjusts each green subpixel data based on two green subpixel data horizontally adjacent to the each green subpixel data and two green subpixel data vertically adjacent to the each green subpixel data among the plurality of green subpixel data in the second pixel arrangement structure, and adjusts each blue subpixel data based on two blue subpixel data horizontally adjacent to the each blue subpixel data and two blue subpixel data vertically adjacent to the each blue subpixel data among the plurality of blue subpixel data in the second pixel arrangement structure.

5. The display device of claim 1, wherein the input image data includes a plurality of red subpixel data, a plurality of green subpixel data and a plurality of blue subpixel data, and
wherein, in the resolution-reduction rendering operation, the panel driver adjusts each red subpixel data based on four red subpixel data diagonally adjacent to the each red subpixel data among the plurality of red subpixel data in the second pixel arrangement structure, adjusts each green subpixel data based on four green subpixel data diagonally adjacent to the each green subpixel data among the plurality of green subpixel data in the second pixel arrangement structure, and adjusts each blue subpixel data based on four blue subpixel data diagonally adjacent to the each blue subpixel data among the plurality of blue subpixel data in the second pixel arrangement structure.

6. The display device of claim 1, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data horizontally adjacent to the each red subpixel data, two red subpixel data vertically adjacent to the each red subpixel data, and four red subpixel data diagonally adjacent to the each red subpixel data among the plurality of red subpixel data in the second pixel arrangement structure, adjusts each green subpixel data based on two green subpixel data horizontally adjacent to the each green subpixel data, two green subpixel data vertically adjacent to the each green subpixel data, and four green subpixel data diagonally adjacent to the each green subpixel data among the plurality of green subpixel data in the second pixel arrangement structure, and adjusts each blue subpixel data based on two blue subpixel data horizontally adjacent to the each blue subpixel data, two blue subpixel data vertically adjacent to the each blue subpixel data, and four blue subpixel data diagonally adjacent to the each blue subpixel data among the plurality of blue subpixel data in the second pixel arrangement structure.

7. The display device of claim 1, wherein in the first pixel arrangement structure, each subpixel includes two first color subpixels, one second color subpixel, and one third color subpixel, which are arranged at four corners of a diamond shapes, respectively, and the two first color subpixels are arranged at corners opposite to each other among the four corners, and in the second pixel arrangement structure, each subpixel includes one first color subpixel, one second color subpixel, and one third color subpixel, which are sequentially arranged in one direction.

8. The display device of claim 1, wherein the plurality of normal subpixels include normal red subpixels, normal green subpixels and normal blue subpixels,
wherein the plurality of private subpixels include private red subpixels, private green subpixels and private blue subpixels,
wherein one normal red subpixel among the normal red subpixels, two normal green subpixels among the normal green subpixels, and one normal blue subpixel among the normal blue subpixels are arranged at four corners of a diamond shape, respectively, and
wherein one private red subpixel among the private red subpixels, two private green subpixels among the private green subpixels, and one private blue subpixel among the private blue subpixels are arranged at four corners of a diamond shape, respectively.

9. The display device of claim 8, wherein the input image data includes a plurality of red subpixel data, a plurality of green subpixel data and a plurality of blue subpixel data, and
wherein, in the pixel arrangement rendering operation, the panel driver generates each subpixel data for each of the normal red subpixels or each of the private red subpixels based on adjacent two red subpixel data among the plurality of red subpixel data, generates each subpixel data for each of the normal green subpixels or each of the private green subpixels based on adjacent two green subpixel data among the plurality of green subpixel data, and generates each subpixel data for each of the normal blue subpixels or each of the private blue subpixels based on adjacent two blue subpixel data among the plurality of blue subpixel data.

10. The display device of claim 1, wherein, in the private rendering operation, the panel driver converts the subpixel data for the plurality of normal subpixels into minimum level data among the subpixel data included in the input image data on which the resolution-reduction rendering operation and the pixel arrangement rendering operation are performed.

11. The display device of claim 1, wherein the panel driver includes:
a scan driver, which provides scan signals to the plurality of normal subpixels and the plurality of private subpixels;
a data driver, which provides data signals to the plurality of normal subpixels and the plurality of private subpixels based on the first output data in the normal mode, and provides data signals to the plurality of private subpixels based on the second output data in the private mode; and
a controller, which generates the first output image data by performing the pixel arrangement rendering operation on the input image data in the normal mode, and generates the second output image data by performing the resolution-reduction rendering operation, the pixel arrangement rendering operation and the private rendering operation on the input image data in the private mode.

12. The display device of claim 11, wherein the controller includes:
a resolution-reduction rendering block, which performs the resolution-reduction rendering operation on the input image data in the private mode;
a pixel arrangement rendering block, which performs the pixel arrangement rendering operation on the input image data in the normal mode, and performs the pixel arrangement rendering operation on the input image data on which the resolution-reduction rendering operation is performed in the private mode; and
a mode rendering block, which performs the private rendering operation on the input image data on which the resolution-reduction rendering operation and the pixel arrangement rendering operation are performed in the private mode.

13. A display device comprising:
a display panel including a plurality of normal subpixels having a first viewing angle and a plurality of private subpixels having a second viewing angle different from the first viewing angle, the plurality of normal subpixels and the plurality of private subpixels being arranged in a first pixel arrangement structure; and
a panel driver, which receives input image data corresponding to a second pixel arrangement structure different from the first pixel arrangement structure, and drives the display panel,
wherein, in a normal mode, the panel driver performs a resolution-reduction rendering operation, which adjusts each subpixel data included in the input image data based on adjacent subpixel data included in the input image data, performs a pixel arrangement rendering operation on the input image data on which the resolution-reduction rendering operation is performed, performs a normal rendering operation on the input image data on which the resolution-reduction rendering operation and the pixel arrangement rendering operation are performed to generate first output image data, and drives only the plurality of normal subpixels among the plurality of normal subpixels and the plurality of private subpixels based on the first output image data, and
wherein, in a private mode, the panel driver performs the resolution-reduction rendering operation on the input image data, performs the pixel arrangement rendering operation on the input image data on which the resolution-reduction rendering operation is performed, performs a private rendering operation on the input image data on which the resolution-reduction rendering operation and the pixel arrangement rendering operation are performed to generate second output image data, and drives only the plurality of private subpixels among the plurality of normal subpixels and the plurality of private subpixels based on the second output image data.

14. The display device of claim 13, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data horizontally adjacent to the each red subpixel data among the plurality of red subpixel data in the second pixel arrangement structure, adjusts each green subpixel data based on two green subpixel data horizontally adjacent to the each green subpixel data among the plurality of green subpixel data in the second pixel arrangement structure, and adjusts each blue subpixel data based on two blue subpixel data horizontally adjacent to the each blue subpixel data among the plurality of blue subpixel data in the second pixel arrangement structure.

15. The display device of claim 13, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data vertically adjacent to the each red subpixel data among the plurality of red subpixel data in the second pixel arrangement structure, adjusts each green subpixel data based on two green subpixel data vertically adjacent to the each green subpixel data among the plurality of green subpixel data in the second pixel arrangement structure, and adjusts each blue subpixel data based on two blue subpixel data vertically adjacent to the each blue subpixel data among the plurality of blue subpixel data in the second pixel arrangement structure.

16. The display device of claim 13, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data horizontally adjacent to the each red subpixel data and two red subpixel data vertically adjacent to the each red subpixel data among the plurality of red subpixel data in the second pixel arrangement structure, adjusts each green subpixel data based on two green subpixel data horizontally adjacent to the each green subpixel data and two green subpixel data vertically adjacent to the each green subpixel data among the plurality of green subpixel data in the second pixel arrangement structure, and adjusts each blue subpixel data based on two blue subpixel data horizontally adjacent to the each blue subpixel data and two blue subpixel data vertically adjacent to the each blue subpixel data among the plurality of blue subpixel data in the second pixel arrangement structure.

17. The display device of claim 13, wherein the input image data includes a plurality of red subpixel data, a plurality of green subpixel data and a plurality of blue subpixel data, and
wherein, in the resolution-reduction rendering operation, the panel driver adjusts each red subpixel data based on four red subpixel data diagonally adjacent to the each red subpixel data among the plurality of red subpixel data in the second pixel arrangement structure, adjusts each green subpixel data based on four green subpixel data diagonally adjacent to the each green subpixel data among the plurality of green subpixel data in the second pixel arrangement structure, and adjusts each blue subpixel data based on four blue subpixel data diagonally adjacent to the each blue subpixel data among the plurality of blue subpixel data in the second pixel arrangement structure.

18. The display device of claim 13, wherein the input image data includes a plurality of red subpixel data, a plurality of green subpixel data and a plurality of blue subpixel data, and
wherein, in the resolution-reduction rendering operation, the panel driver adjusts each red subpixel data based on two red subpixel data horizontally adjacent to the each red subpixel data, two red subpixel data vertically adjacent to the each red subpixel data, and four red subpixel data diagonally adjacent to the each red subpixel data among the plurality of red subpixel data in the second pixel arrangement structure, adjusts each green subpixel data based on two green subpixel data horizontally adjacent to the each green subpixel data, two green subpixel data vertically adjacent to the each green subpixel data, and four green subpixel data diagonally adjacent to the each green subpixel data among the plurality of green subpixel data in the second pixel arrangement structure, and adjusts each blue subpixel data based on two blue subpixel data horizontally adjacent to the each blue subpixel data, two blue subpixel data vertically adjacent to the each blue subpixel data, and four blue subpixel data diagonally adjacent to the each blue subpixel data among the plurality of blue subpixel data in the second pixel arrangement structure.

19. The display device of claim 13, wherein, in the normal rendering operation, the panel driver converts the subpixel data for the plurality of private subpixels into minimum level data among the subpixel data included in the input image data on which the resolution-reduction rendering operation and the pixel arrangement rendering operation are performed, and
wherein, in the private rendering operation, the panel driver converts the subpixel data for the plurality of normal subpixels into the minimum level data among the subpixel data included in the input image data on which the resolution-reduction rendering operation and the pixel arrangement rendering operation are performed.

20. An electronic device comprising:
a processor, which provides input image data and a mode signal;
a display panel including a plurality of normal subpixels having a first viewing angle and a plurality of private subpixels having a second viewing angle different from the first viewing angle, the plurality of normal subpixels and the plurality of private subpixels being arranged in a first pixel arrangement structure; and
a panel driver, which receives the input image data corresponding to a second pixel arrangement structure different from the first pixel arrangement structure from the processor, receives the mode signal indicating a normal mode or a private mode from the processor, and drives the display panel,
wherein, in a case where the mode signal indicates the private mode, the panel driver performs a resolution-reduction rendering operation, which adjusts each subpixel data included in the input image data based on adjacent subpixel data included in the input image data, performs a pixel arrangement rendering operation on the input image data on which the resolution-reduction rendering operation is performed, performs a private rendering operation on the input image data on which the resolution-reduction rendering operation and the pixel arrangement rendering operation are performed to generate output image data, and drives only the plurality of private subpixels among the plurality of normal subpixels and the plurality of private subpixels based on the output image data.
